(19) United States
(12) Patent Application Publication
(10) Pub. No.: US 2011/0078307 A1
(43) Pub. Date: Mar. 31, 2011

(54) COOPERATIVE SYSTEM AND COOPERATIVE PROCESSING METHOD AMONG MEDICAL SECTORS AND COMPUTER READABLE MEDIUM

(75) Inventors: Takayoshi KIUCHI, Tokyo (JP); Kunimasa SHIMIZU, Tokyo (JP); Ryojiro SASAGE, Kanagawa (JP); Shinji KOSUKEGAWA, Kanagawa (JP); Hiroshi OHKI, Kanagawa (JP); Shinichi SHIDARA, Tokyo (JP); Goro MIURA, Tokyo (JP); Koichiro MIYAZAKI, Tokyo (JP); Yasuhiro ASAI, Tokyo (JP)

(73) Assignee: FUJIFILM CORPORATION, Tokyo (JP)

(21) Appl. No.: 12/894,223

(22) Filed: Sep. 30, 2010

(30) Foreign Application Priority Data
Sep. 30, 2009 (JP) P2009-228674
Aug. 31, 2010 (JP) P2010-195232

(51) Int. Cl. G06F 15/173

(52) U.S. Cl. 709/224

(57) ABSTRACT

A cooperative processing method includes: transmitting pathological inspection request information from an endoscopic sector to a pathological sector, the pathological inspection request information being created by use of an endoscopic inspection report and for requesting the pathological sector to perform pathological inspection; managing status information for the pathological inspection request received on the pathological sector side; issuing a request to change the transmitted pathological inspection request information corresponding to the report when there occurs a change in the report; acquiring the status information of the pathological inspection request information upon reception of the change request and determining whether the pathological inspection request information can be changed or not; and changing the pathological inspection request information when it is concluded that the pathological inspection request information can be changed, and transmitting a change rejection notification when it is concluded that the pathological inspection request information cannot be changed.

### CROSS-REFERENCE TO RELATED APPLICATIONS

This application is based on and claims priority under 35 USC 119 from Japanese Patent Application Nos. 2009-228674 filed on Sep. 30, 2009 and 2010-195232 filed on Aug. 31, 2010; the entire contents of which are incorporated herein by reference.

### BACKGROUND

1. Technical Field

The present invention relates to a cooperative system among medical sectors, which system is used for supporting cooperation of intersectoral inspection orders between an endoscopic sector and a pathological sector.

2. Related Art

An inspection management system or an image filing system with computers introduced therein has been constructed among sectors such as an endoscopic sector, a pathological sector, etc. in a hospital. However, systems in the sectors often work independently of one another. It is therefore requested to enhance the intersectoral cooperativity. In an ordinary hospital, a pathological inspection request document (paper) together with a biopsy is conveyed from an endoscopic sector to a pathological sector to make a request for pathological inspection. In recent years, the pathological inspection request document has been transmitted as electronic data from the endoscopic sector to the pathological sector via a hospital LAN (Local Area Network) which is a communication network.

For example, Patent Document 1 (JP-A-2003-38413) and Patent Document 2 (JP-A-2001-125999) disclose a pathological inspection request in a hospital.

In Patent Document 1, a report created in an endoscopic inspection sector is also used to issue a pathological inspection request document for ordering a pathological inspection to a pathological inspection sector. Thus, the pathological inspection request document can be created in a simple procedure based on the inspection report created in the endoscopic inspection sector.

In Patent Document 2, there is disclosed a system in which electronic data of pathological inspection request information, endoscopic inspection reports and pathological inspection reports can be transmitted and received between an endoscopic sector and a pathological inspection sector so as to be used intersectorally.

When there is an error in the contents of the created endoscopic inspection report after the pathological inspection request document is transmitted from the endoscopic sector to the pathological sector, the error must be corrected immediately. When the endoscopic sector side causes the necessity of changing a pathological inspection request document, the pathological inspection sector can make this change before processing the inspection in question (before acceptance, before execution of the inspection, or the like). However, this change cannot be made if the inspection has been already executed. In consideration of such circumstances, a person in charge must determine whether the pathological inspection request document can be changed or not. Thus, this leads to a reality that the burden on the pathological sector is increased.

The technique in Patent Document 1 has no mechanism for changing an already requested pathological inspection order when a point to be changed is found in the report. Thus, the technique cannot deal with the aforementioned necessity of changing a pathological inspection request document. The technique in Patent Document 2 cannot serve to work with the pathological sector because no assumption is given to the case where the contents of a pathological inspection should be corrected. It is therefore impossible to change the contents of a pathological inspection request.

### SUMMARY

An illustrative aspect of the invention is to provide a cooperative system and a cooperative processing method among medical sectors, in which data consistency can be secured between an endoscopic sector and a pathological sector when a request to change a part of data is issued from one of the sectors in the case where at least a part of data such as a document is shared and used between the sectors, and to provide a computer readable medium storing the cooperative processing method.

[1] According to an aspect of the invention, a cooperative system among medical sectors for allowing an endoscopic sector and a pathological sector to share at least a part of information included in an endoscopic inspection report, includes: an endoscopic sector server; a pathological sector server which is connected to the endoscopic sector server through a communication network; a pathological inspection request information transmission unit which transmits pathological inspection request information from the endoscopic sector to the pathological sector, the pathological inspection request information being created by use of at least a part of information included in the endoscopic inspection report and for requesting the pathological sector to perform pathological inspection; a pathological sector status information management unit which receives the transmitted pathological inspection request information on the pathological sector server side and manages status information indicating a state of processing on the received pathological inspection request information in the pathological sector; a change request unit which issues a change request to change the transmitted pathological inspection request information corresponding to the endoscopic inspection report when there occurs a change in the information of the endoscopic inspection report; a change validity determination unit which acquires the status information of the pathological inspection request information to be changed from the pathological sector status information management unit upon reception of the change request from the change request unit, and determines whether the pathological inspection request information can be changed or not; and a change execution unit which changes the corresponding pathological inspection request information based on the change request when the change validity determination unit concludes that the pathological inspection request information can be changed, and transmits a change rejection notification indicating rejection of the change request to the endoscopic sector when the change validity determination unit concludes that the pathological inspection request information cannot be changed.

[2] According to another aspect of the invention, a cooperative processing method among medical sectors using a system having an endoscopic sector server and a pathological sector server connected to each other through a communication network, and allowing an endoscopic sector and a pathological sector to share at least a part of information included in an endoscopic inspection report, includes: transmitting pathological inspection request information from the endoscopic sector to the pathological sector, the pathological inspection request information being created by use of at least a part of information included in the endoscopic inspection report and for requesting the pathological sector to perform pathological inspection; receiving the transmitted pathological inspection request information on the pathological sector server side and managing status information indicating a state of processing on the received pathological inspection request information in the pathological sector; issuing a change request to change the transmitted pathological inspection request information corresponding to the endoscopic inspection report when there occurs a change in the information of the endoscopic inspection report; and acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

[3] A computer readable medium storing a program causing a computer to execute a process for a cooperative processing method among medical sectors using a system having an endoscopic sector server and a pathological sector server connected to each other through a communication network, and allowing an endoscopic sector and a pathological sector to share at least a part of information included in an endoscopic inspection report, the process includes: transmitting pathological inspection request information from the endoscopic sector to the pathological sector, the pathological inspection request information being created by use of at least a part of information included in the endoscopic inspection report and for requesting the pathological sector to perform pathological inspection; receiving the transmitted pathological inspection request information on the pathological sector server side and managing status information indicating a state of processing on the received pathological inspection request information in the pathological sector; issuing a change request to change the transmitted pathological inspection request information corresponding to the endoscopic inspection report when there occurs a change in the information of the endoscopic inspection report; and acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

With the configuration of any one of [1] to [3], data consistency can be secured between an endoscopic sector and a pathological sector when a request to change a part of data is issued from one of the sectors in the case where at least a part of data such as a document is shared and used between the sectors. ‘Thus, the data can be corrected depending on circumstances. That is, the contents of a pathological inspection request document can be changed if a pathological inspection has not yet been accepted in the pathological sector, and cannot be changed if the pathological inspection has been accepted.

### BRIEF DESCRIPTION OF THE DRAWINGS

FIG. 1 is a block diagram for explaining an embodiment of the invention, showing an overall configuration of a hospital system.

FIG. 2 is a block diagram showing a schematic configuration of an endoscopic sector system in the system shown in FIG. 1.

FIG. 3 is a block diagram showing a detailed configuration of a part of the endoscopic sector system shown in FIG. 2.

FIG. 4 is a block diagram showing a detailed configuration of a pathological sector system in the system shown in FIG. 1.

FIG. 5 is an explanatory view schematically showing the flow of treatment on a patient per se in a hospital and the state of information distribution among an endoscopic sector, a pathological sector and a hospital information system (HIS).

FIG. 6 is an explanatory view showing an example of display of a pathological inspection request screen.

FIG. 7 is an explanatory view showing an example of display of an endoscopic inspection report screen.

FIG. 8 is a flow chart showing main operation about the endoscopic sector system shown in FIG. 3.

FIG. 9 is a flow chart showing main operation about the pathological sector system shown in FIG. 4.

FIG. 10 is a schematic view showing main functions provided by a program installed in each client PC and state transitions among the functions.

FIG. 11 is an explanatory view showing an example of a screen to be displayed when a login function is actuated.

FIG. 12 is an explanatory view showing an example of a screen to be displayed when an order retrieval function is actuated.

FIG. 13 is an explanatory view showing an example of a screen to be displayed when the order retrieval function is actuated.

FIG. 14 is an explanatory view showing an example of a screen to be displayed when an interview/pretreatment function is actuated.

FIG. 15 is an explanatory view showing an example of a screen to be displayed when the interview/pretreatment function is actuated.

FIG. 16 is an explanatory view showing an example of a screen to be displayed when an image display function is actuated.

FIG. 17 is an explanatory view showing an example of a screen to be displayed when the image display function is actuated.

FIG. 18 is an explanatory view showing an example of a screen to be displayed when a report registration function is actuated.

FIG. 19 is an explanatory view showing an example of a screen to be displayed when a pathological inspection request function is actuated.

FIG. 20 is an explanatory view showing an example of a screen to be displayed when a practice report function is actuated.

FIG. 21 is an explanatory view showing an example of a screen to be displayed when a logout function is actuated.

### DETAILED DESCRIPTION

An exemplary embodiment of the invention will be described below in detail with reference to the drawings.

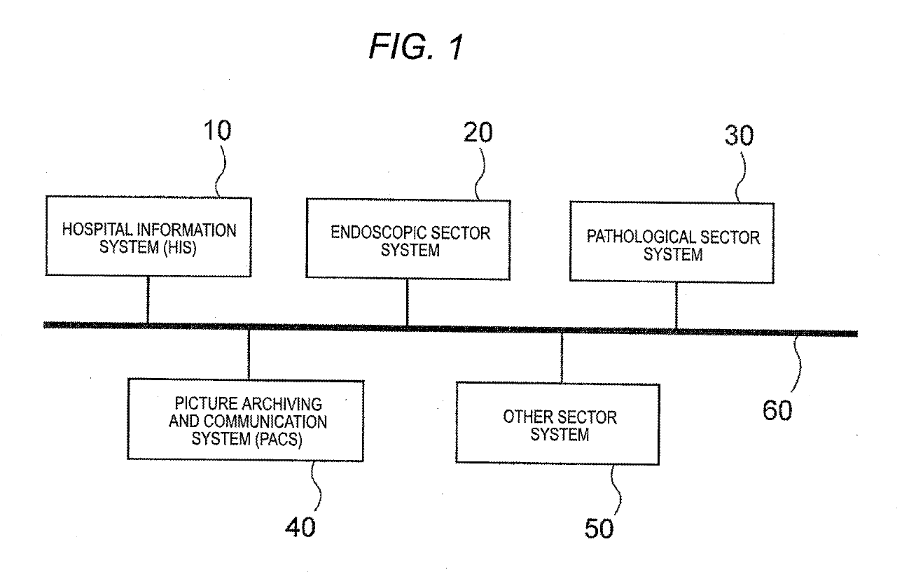

FIG. 1 shows an overall configuration of a hospital system. The system includes a hospital information system (HIS) 10, an endoscopic sector system 20, a pathological sector system 30, a picture archiving and communication system (PACS) 40, and an other sector system 50. These systems 10 to 50 are connected to a hospital LAN 60 so that these systems 10 to 50 can work with one another.

The HIS 10 is a comprehensive system including a medical coding/billing system, a medical practice reservation system, a medical practice information system, etc. The HIS 10 has an electronic medical record database etc. Electronic medical records in which medical practice information of patients has been recorded are stored in the electronic medical record database.

The endoscopic sector system 20 is a system for administering an endoscopic sector. The pathological sector system 30 is a system for administering a pathological sector. The PACS 40 is a system for electronically storing, retrieving and analyzing each inspection image from a medical image diagnostic device as an endoscopic inspection device, a CT or an MRI. The other sector system 50 is a system for administering the other sectors.

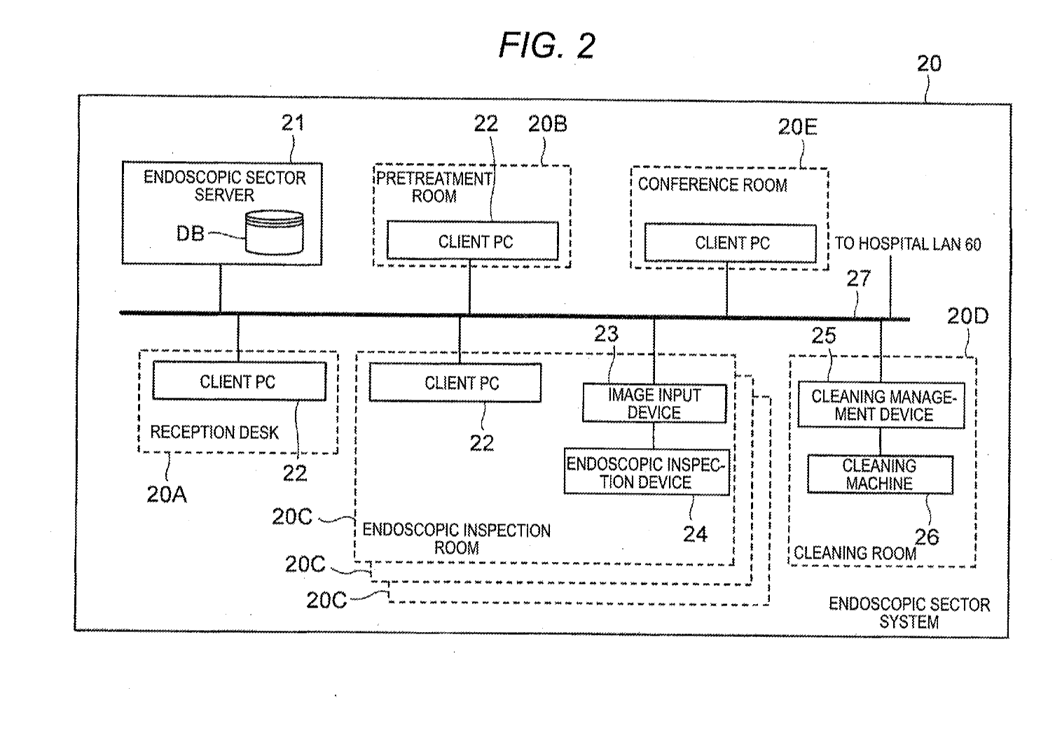

FIG. 2 shows a schematic configuration of the endoscopic sector system in the system shown in FIG. 1. As shown in FIG. 2, the endoscopic sector system includes a reception desk 20A, a pretreatment room 20B, a plurality of endoscopic inspection rooms (hereinafter referred to as inspection rooms) 20C, a cleaning room 20D, and a conference room 20E.

The pretreatment room 20B is a room for interview and pretreatment before endoscopic inspection. The inspection rooms 20C are rooms for endoscopic inspections. The cleaning room 20D is a room for cleaning endoscopes etc. used for endoscopic inspections.

The endoscopic sector system 20 shown in FIG. 2 has an endoscopic sector server 21, client PCs 22, image input devices 23, endoscopic inspection devices 24, a cleaning management device 25 and a cleaning machine 26. The endoscopic sector server 21, the client PCs 22, the image input devices 23 and the cleaning management device 25 are connected to an intrasectoral LAN 27. The intrasectoral LAN 27 is connected to the hospital LAN 60.

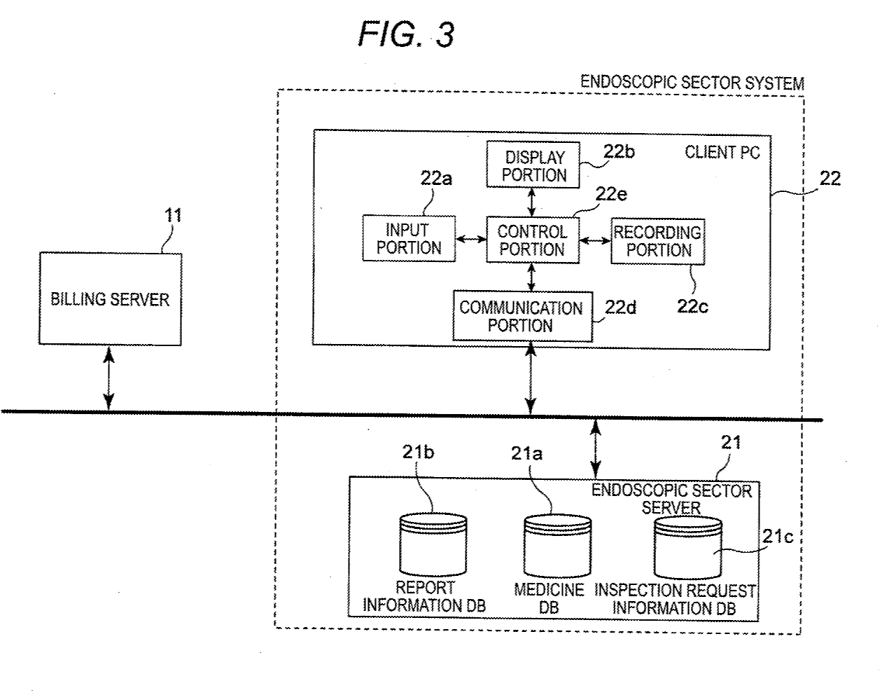

The client PCs 22 are computers which are installed in the reception desk 20A, the pretreatment room 20B, the endoscopic inspection rooms 20C and the conference room 20E respectively. As shown in FIG. 3, each client PC 22 in the endoscopic sector system is constituted by an input portion 22a, a display portion 22b, a recording portion 22c, a communication portion 22d and a control portion 22e.

The input portion 22a is constituted by input devices such as a keyboard and a touch panel, and pointing devices such as a mouse and a trackball. The display portion 22b is a display unit for performing various displays such as an image and a report. The display portion 22b is constituted by an LCD, a CRT or the like.

The recording portion 22c is constituted by a hard disk or the like for recording various data. The communication portion 22d is constituted by a transmission/reception interface circuit or the like. The communication portion 22d executes processing for transmitting/receiving various instructions, various requests and various data through the intrasectoral LAN 27.

The control portion 22e includes a processor such as a CPU (Central Processing Unit), a program storage portion such as a ROM (Read-Only Memory) for storing programs, and a storage medium (all not shown). One of the programs stored in the program storage portion is a specimen management program for managing specimens. The storage medium is constituted by a system memory, a RAM (Random Access Memory), etc., which forms work areas for executing the programs. The control portion 22e controls each portion of the client PC 22 in accordance with the programs, various requests transmitted from the outside through the intrasectoral LAN 27, instruction information supplied from the input portion 22a, etc.

In addition, as shown in FIG. 3, the endoscopic sector server 21 has various databases (21a, 21b and 21c). The inspection request information database (hereinafter abbreviated to “DB”) 21c holds inspection request information.

The inspection request information is information about an inspection request (order) issued from another medical department to the endoscopic sector. The inspection request information includes order key information (“order number”, “date and time of occurrence”, etc.), request source information (“requesting department name”, “requesting doctor name”, “request date”, etc.), order information (“requested disease name”, “inspection purpose”, “inspection kind”, “inspection item”, “inspection region”, “comment”, “schema image”, etc.), inspection reservation information (“inspection date”, “practice time”, etc.), etc. These pieces of information are transmitted to a sector system from the HIS 10 serving as an administration system. The order key information is information for specifying one inspection order uniquely.

As shown in FIG. 2, the image input devices 23 and the endoscopic inspection devices 24 are placed in the inspection rooms 20C respectively. Each image input device 23 is connected to the endoscopic inspection device 24 in the inspection room 20C where the image input device 23 is placed. The image input device 23 is a device by which image data obtained by capturing images with the endoscopic inspection device 24 connected thereto is supplied to the endoscopic sector server 21. The image data supplied by the image input device 23 is stored in the PASC 40 under the control of the endoscopic sector server 21. An endoscopic inspection device integrated with the image input device 23 may be used as the endoscopic inspection device 24.

The cleaning machine 26 and the cleaning management device 25 are placed in the cleaning room 20D. The cleaning machine 26 is a device for cleaning endoscopes etc. used for endoscopic inspections. The cleaning management device 25 is a computer which is connected to the cleaning machine 26 and by which information of a cleaning history or the like performed by the cleaning machine 26 is registered in the endoscopic sector server 21.

The endoscopic sector server 21 is a computer which generally controls the client PCs 22, the image input devices 23 and the cleaning management device 25. A database DB is built in the endoscopic sector server 21. Various kinds of information (order information, report information, etc.) are stored in the database DB.

A predetermined application program together with a specimen management program is installed in each client PC 22. Due to the program, the client PC 22 can refer to and edit data recorded in each database (21a, 21b and 21c) and register data in the database.

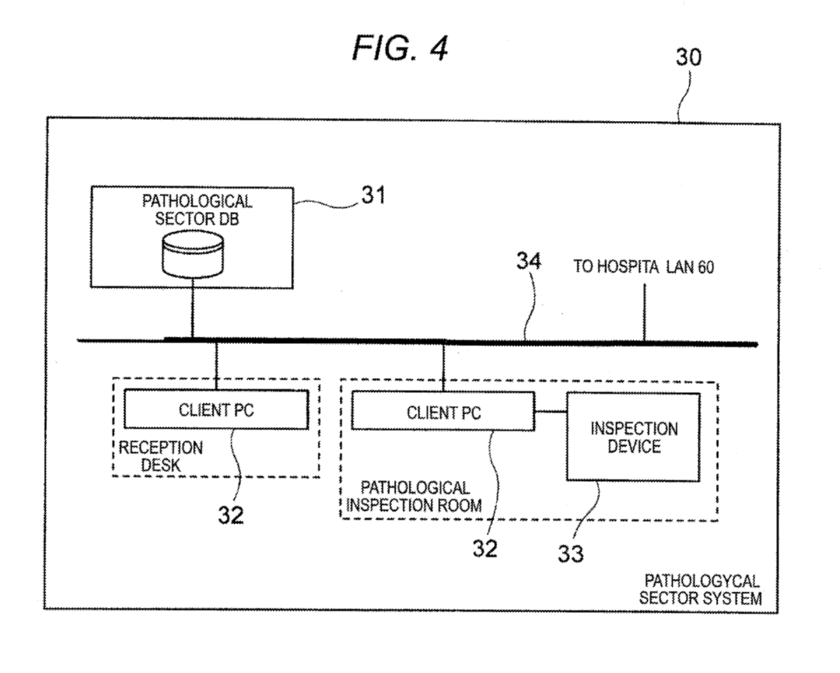

FIG. 4 shows a schematic configuration of the pathological sector system in the system shown in FIG. 1. The pathological sector system 30 shown in FIG. 4 has a pathological sector server 31, client PCs 32 and a pathological inspection device 33. The pathological inspection device 33 may be connected to an intrasectoral LAN 34 or not connected thereto. In addition, the intrasectoral LAN 34 is connected to the hospital LAN 60 so that various kinds of information can be shared.

Though not shown, a “specimen” to be inspected, that is, a biopsy sampled from a living body and put in a container is sent from the endoscopic sector to a reception desk of the pathological sector. In the pathological sector, the “specimen” is accepted, and a pathological inspection is performed thereon at a suitable timing by the inspection device in the pathological inspection room. A pathological inspection result is registered in the pathological sector server 31 by the client PC 32 in the pathological inspection room. Information of the pathological inspection result is also transmitted to the endoscopic sector.

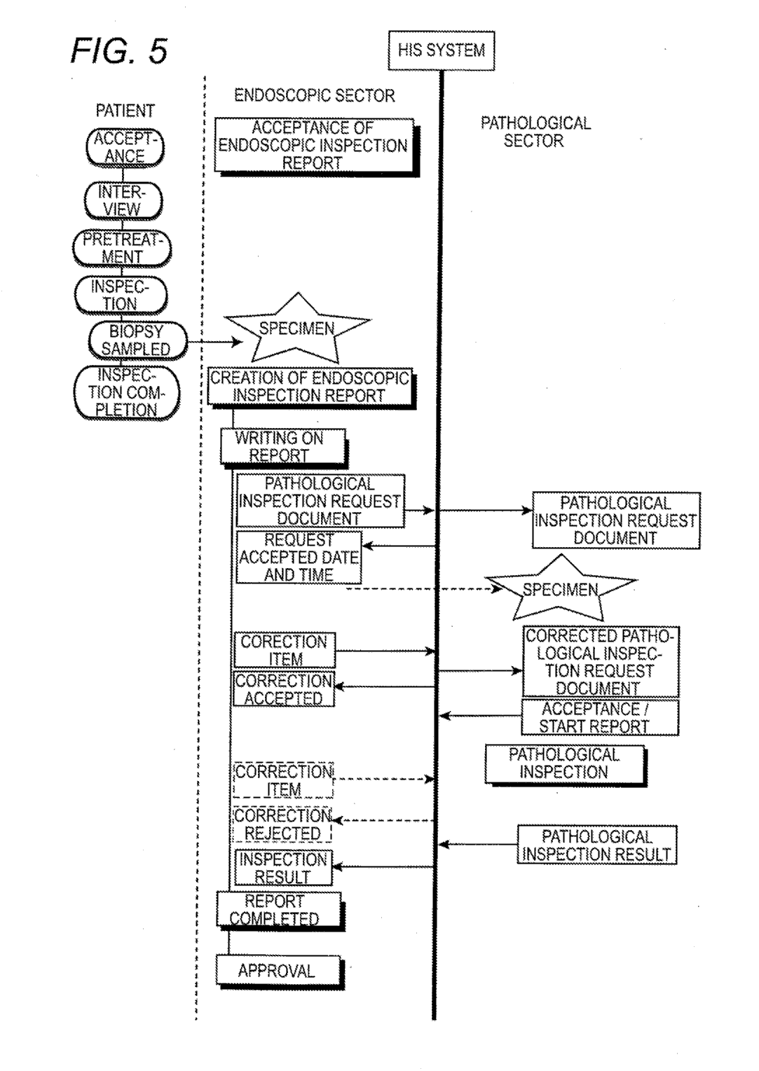

Here, FIG. 5 shows the flow of treatment on a patient per se in the hospital and the schematic state of information distribution among the endoscopic sector, the pathological sector and the hospital information system (HIS). The flow of treatment shown in FIG. 5 will be described below with reference to FIGS. 1 to 3.

First, when a patient visits the hospital and is accepted in the reception desk, acceptance information is transmitted from the HIS to the endoscopic sector system 20 in the endoscopic sector. Here, in the endoscopic sector system 20, the endoscopic sector server 21 generates an endoscopic inspection order for the patient.

Interview and pretreatment are performed on the patient in the endoscopic sector by a medical staff appropriately, and endoscopic inspection is then performed on the patient. In the endoscopic inspection, inspection is performed by use of an endoscope. In addition, a biopsy to be inspected may be sampled from the patient body and extracted as a specimen. The specimen is sent to the pathological sector together with a pathological inspection request document (hard copy).

After the endoscopic inspection on the patient is completed, an endoscopic inspection report is created in the endoscopic sector using the client PC 22. Information about the position where the specimen was sampled, the contents of diagnosis, etc. is written in the endoscopic inspection report. A pathological inspection request document is created using a part of the information written in the report.

The pathological inspection request document is transmitted as electronic data from the endoscopic sector server 21 to a management server of the HIS 10, by which the pathological inspection request document is transferred to the pathological sector server 31 of the pathological sector. On the other hand, a hard copy of the pathological inspection request document is sent from the endoscopic sector to the pathological sector together with a specimen.

In the pathological sector, the electronic data of the pathological inspection request document, that is, a pathological inspection order is delivered to the pathological sector server 31. In addition, the specimen is conveyed to the pathological sector from the endoscopic sector. In accordance with a schedule of a medical staff in the pathological sector, pathological inspection is performed on the specimen at a suitable timing. After the inspection, a pathological inspection result (electronic data) is registered in the pathological sector server 31, and concurrently sent to the endoscopic sector server 21 through the management server of the HIS 10.

In the endoscopic sector, the pathological inspection result is received from the pathological sector, and information of the pathological inspection result is written into the endoscopic inspection report. Thus, the report is completed. The completed endoscopic inspection report is approved by a predetermined approver, and registered as an inspection result in the endoscopic sector server 21.

The contents of a pathological inspection request document created in the endoscopic sector are generated by such an operation that the electronic information of contents of a created endoscopic inspection report is copied and pasted on a display screen. Therefore, the contents of the endoscopic inspection report are ordinarily matched with the contents of the pathological inspection request document.

On the other hand, even after a pathological inspection request is issued (a pathological inspection request document is transmitted), a person in charge in the endoscopic sector may find, for example, an error in the written contents of an endoscopic inspection report. In such a case, the contents of the endoscopic inspection report must be corrected. However, when only the endoscopic inspection report is corrected, the contents of the pathological inspection request document created using the endoscopic inspection report cannot be matched with the corrected contents of the endoscopic inspection report. In addition, even if both the endoscopic inspection report and the pathological inspection request document are wanted to be corrected to ensure consistency therebetween, the pathological inspection request document which has been transmitted to the pathological sector cannot be corrected easily.

That is, endoscopic inspection reports created in the endoscopic sector and pathological inspection request documents corresponding to the endoscopic inspection reports are managed by the endoscopic sector server 21 of the endoscopic sector, while pathological inspection request documents sent from the endoscopic sector to the pathological sector are managed by the pathological sector server 31 of the pathological sector independently. Therefore, when a pathological inspection request document has been accepted in the pathological sector, the pathological inspection request document may not be able to be corrected (or should not be corrected easily). In such a case, a procedure for correcting the contents of the pathological inspection request document while keeping the consistency is not easy.

This system is therefore mounted with a function to allow the system of the endoscopic sector and the system of the pathological sector to work together so as to facilitate a procedure for correcting a created endoscopic inspection report and a pathological inspection request document corresponding thereto.

That is, when a pathological inspection request has been issued based on an endoscopic inspection report which should be corrected in the endoscopic sector, an inspection status of the pathological sector is confirmed. In this timing, if an order of pathological inspection on a specimen has been registered in the pathological sector but the pathological inspection has not been started substantially, the contents of a pathological inspection request document are rewritten based on the corrected contents of the endoscopic inspection report. In the pathological sector, the inspection is performed based on the rewritten pathological inspection request document. On the other hand, when the confirmation timing is later than the start of the pathological inspection, the correction of the pathological inspection request document is not accepted but a notification signal indicating rejection of the correction acceptance is transmitted to the endoscopic sector.

Here, it can be supposed that at least one of the following kinds of conditions is used as a criterion for distinguishing whether pathological inspection has been started or not.
(1) Whether a pathological inspection request document has been delivered to the pathological sector server and registered as a pathological inspection request order by the pathological sector server or not.
(2) Whether a medical staff of the pathological sector has actually started the pathological inspection based on the pathological inspection request order or not.
(3) Whether a specimen has arrived at the pathological sector and has been accepted or not.

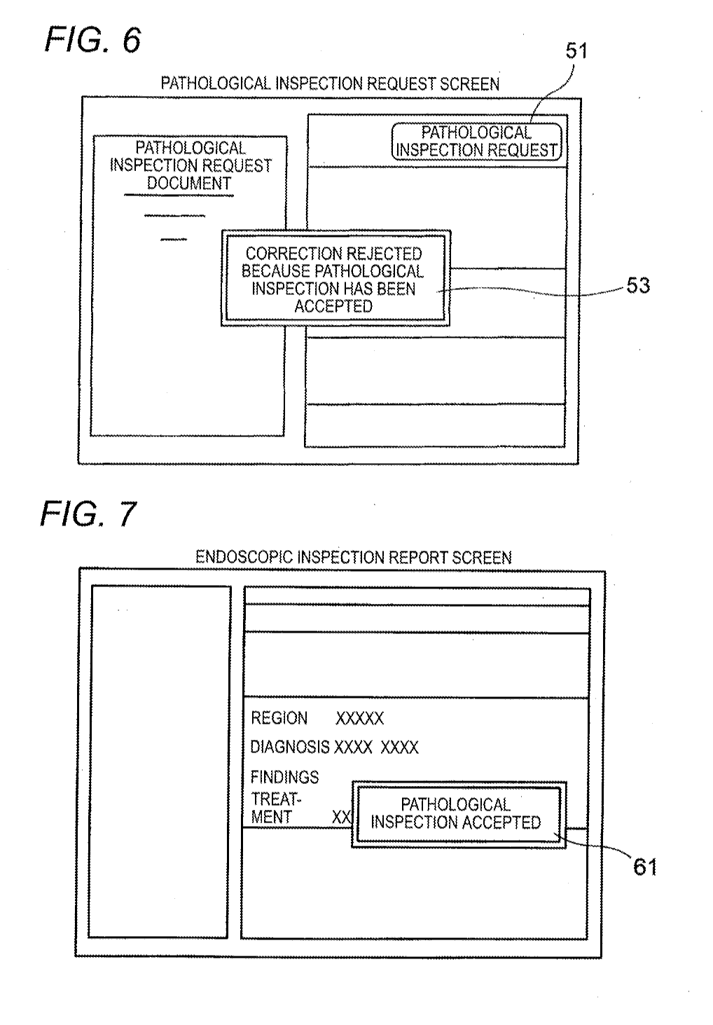

Assume that a pathological inspection request is issued again from the endoscopic sector system because an endoscopic inspection report should be corrected after pathological inspection has been substantially started. In this case, when a pathological inspection request button 51 is pushed down on a pathological inspection request screen as shown in FIG. 6, a notification window 53, which, for example, shows “correction rejected because pathological inspection has been accepted” is displayed in the pathological inspection request screen.

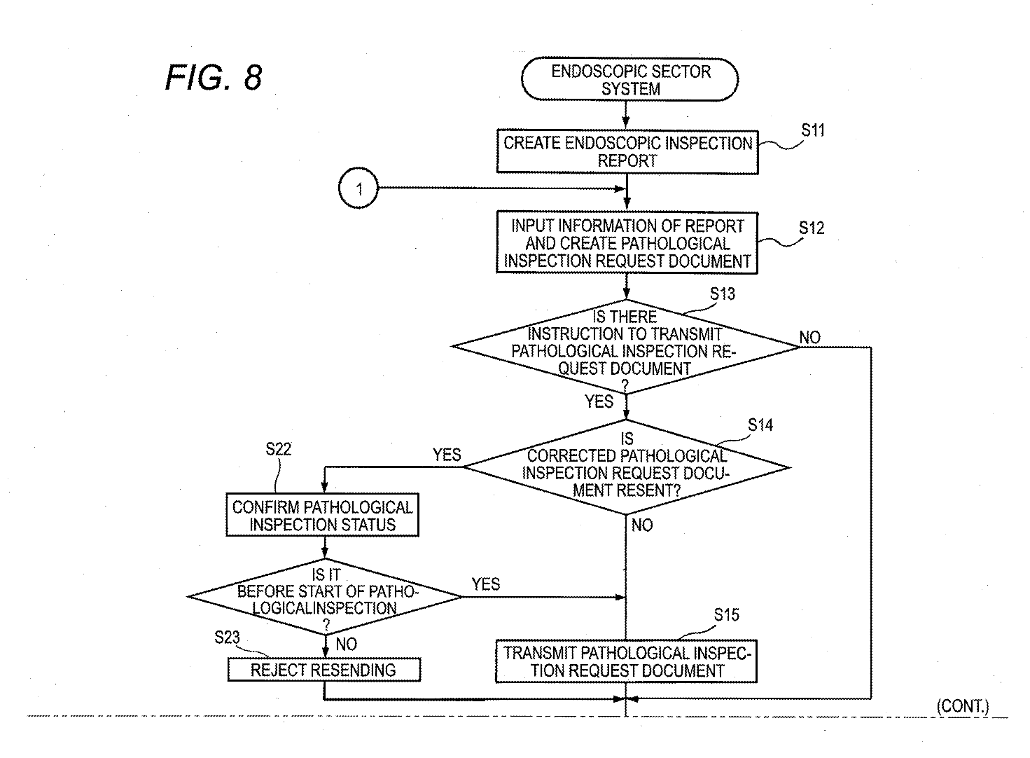

On the other hand, assume that a pathological inspection request for an endoscopic inspection report whose contents are being corrected has been issued and pathological inspection has been substantially started. In this case, when a return key is pushed down (decided) after corrected information is inputted, a notification window 61, which, for example, shows “pathological inspection accepted” is displayed on an endoscopic inspection report screen as shown in FIG. 7.

In the endoscopic sector, such a notification window appears on the display screen of the client PC. Thus, processing for confirming the status of each inspection with the pathological sector can be performed automatically to exclude a troublesome inquiry such as phone contact about the inspection. On the other hand, when there appears no notification window, it can be recognized that correction has been completed without any special problem before the pathological inspection is performed. The notification may be performed by another means such as voice, besides display of a window on the display screen.

The aforementioned function for allowing sectors to work together is specifically implemented by a program installed in the client PC 22 or the endoscopic sector server 21 of the endoscopic sector system 20, and a program installed in the client PC 32 or the pathological sector server 31 of the pathological sector system 30.

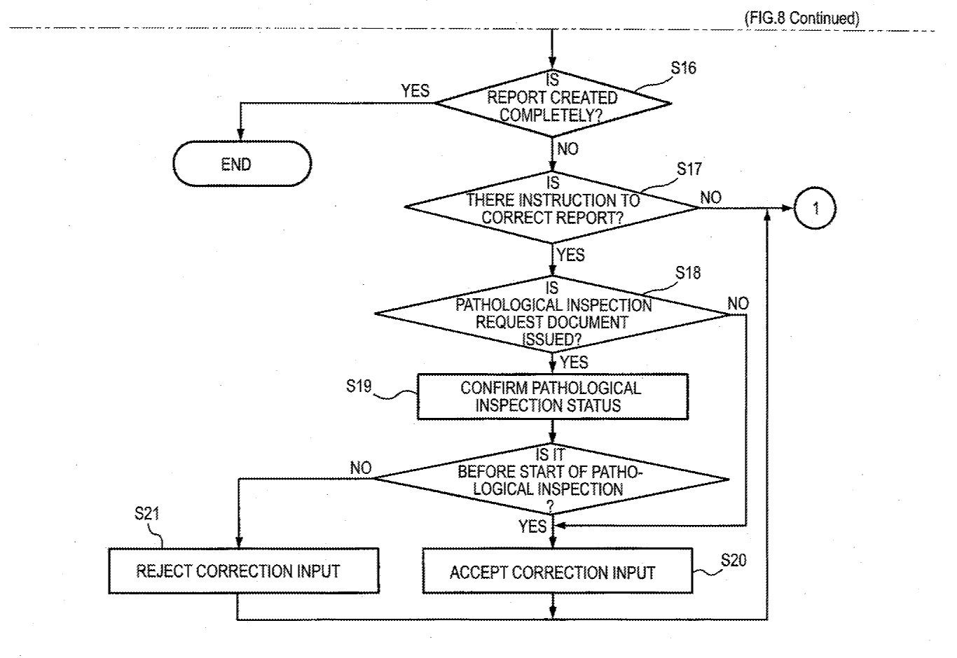

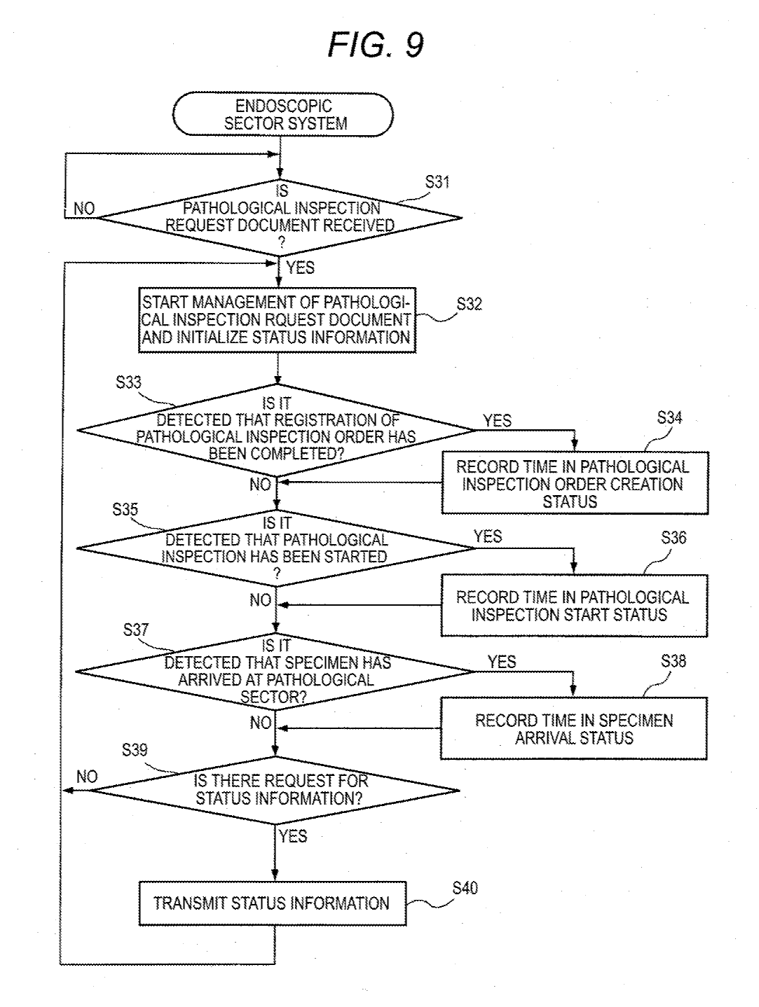

The main operation on the endoscopic sector system 20 side and the main operation on the pathological sector system 30 side implemented by execution of the programs are shown in FIGS. 8 and 9 respectively. Those operations are shown here by way of example. A part of processing shown in FIG. 8 may be implemented on the pathological sector system 30 side, and a part of processing shown in FIG. 9 may be implemented on the endoscopic sector system 20 side.

The operations shown in FIGS. 8 and 9 will be described below.

In Step S11 of FIG. 8, the client PC 22 of the endoscopic sector system 20 is operated to create a blank endoscopic inspection report (electronic data).

In the next Step S12, by input operation of a person in charge of endoscopic inspection, information showing a result of the endoscopic inspection is written into the endoscopic inspection report created in Step S11. In addition, when pathological inspection on a specimen sampled in the endoscopic inspection should be requested to the pathological sector, the person in charge operates the client PC 22 to create electronic data of a pathological inspection request document. The contents of the pathological inspection request document are obtained by copying and pasting information inputted into the endoscopic inspection report. Thus, the contents of the endoscopic inspection report are matched with the contents of the pathological inspection request document.

When there is a predetermined transmission instruction, the endoscopic sector system advances its processing from Step S13 to Step S15 through Step S14 in FIG. 8. In Step S15, the electronic data of the pathological inspection request document created in Step S12 is transmitted to the pathological sector by the endoscopic sector server 21.

The pathological sector server 31 of the pathological sector system 30 receives the pathological inspection request document transmitted from the endoscopic sector system in Step S15 of FIG. 8. Upon reception of the pathological inspection request document, the pathological sector system 30 advances its processing from Step S31 to Step S32 in FIG. 9. In Step S32, the pathological sector server 31 begins to manage the received pathological inspection request document, and initializes status information indicating the processing status of the pathological inspection request document. In this example, three items, that is, “pathological inspection order creation status”, “pathological inspection start status” and “specimen arrival status” arc managed as the status information of each pathological inspection request document.

When the pathological sector server 31 detects completion of registration of a pathological inspection request order for the corresponding pathological inspection request document, the pathological sector server 31 advances its processing from Step S33 to Step S34 in FIG. 9. In Step S34, the pathological sector server 31 acquires information of current time from a built-in clock, and records the information of current time into the “pathological inspection order creation status”.

In addition, when the pathological sector server 31 detects the state where pathological inspection based on the pathological inspection request document has been substantially started, that is, a medical staff of the pathological sector has actually started pathological inspection based on the pathological inspection request order, the pathological sector server 31 advances its processing from Step S35 to Step S36 in FIG. 9. In Step S36, the pathological sector server 31 acquires information of current time from the built-in clock, and records the information of current time into the “pathological inspection start status”.

In addition, when the pathological sector server 31 detects the state where a specimen corresponding to the order of the pathological inspection request document has arrived at the pathological sector and been accepted, the pathological sector server 31 advances its processing from Step S37 to Step S38 in FIG. 9. In Step S38, the pathological sector server 31 acquires information of current time from the built-in clock, and records the information of current time into the “specimen arrival status”.

Upon reception of a request for status information from the endoscopic sector system 20, the pathological sector server 31 advances its processing from Step S39 to Step S40 in FIG. 9. In Step S40, the pathological sector server 31 notifies the endoscopic sector system 20 (as a request sender) of all the contents of the “pathological inspection order creation status”, the “pathological inspection start status” and the “specimen arrival status”.

On the other hand, when an input operation for correcting the contents of an endoscopic inspection report which is being created in the endoscopic sector is performed by the client PC 22, the endoscopic sector system 20 advances its processing from Step S17 to Step S18 in FIG. 8. In Step S18, the endoscopic sector system 20 determines whether a pathological inspection request has been issued or not (transmitted or not) for a pathological inspection request document corresponding to the endoscopic inspection report to be corrected, based on a transmission history. The endoscopic sector system 20 advances to Step S19 when the pathological inspection request has been issued, and to Step S20 when the pathological inspection request has not been transmitted.

In. Step S19, the endoscopic sector system 20 confirms the pathological inspection status. Specifically, a request to transmit status information about the pathological inspection request document in question is issued from the endoscopic sector server 21 to the pathological sector server 31. The endoscopic sector server 21 distinguishes the state of the status information notified by the pathological sector server 31, and determines whether pathological inspection has been started or not.

That is, the pathological sector server 31 sends the aforementioned items “pathological inspection order creation status”, “pathological inspection start status” and “specimen arrival status” as the status information. With reference to at least one of those items, the endoscopic sector server 21 determines whether pathological inspection has been started or not. That is, when valid time information is included in the status information, the endoscopic sector server 21 can conclude that an order has been accepted in the pathological sector or pathological inspection has been substantially started.

When the endoscopic sector server 21 recognizes in Step S19 that pathological inspection has not yet been started, the endoscopic sector server 21 then advances its processing to Step S20. On the contrary, when the endoscopic sector server 21 recognizes that pathological inspection has been started, the endoscopic sector server 21 then advances its processing to Step S21.

In Step S20, a correction input is accepted from a person in charge of the endoscopic inspection report in question, and the contents of the endoscopic inspection report are updated. In addition, the contents of the pathological inspection request document are also corrected to reflect the corrected contents of the endoscopic inspection report.

In Step S21, inspection has been substantially started in the pathological sector in response to the request of the pathological inspection request document corresponding to the endoscopic inspection report to be corrected. Therefore, the input for correcting the endoscopic inspection report is rejected. That is, the notification window 61 which, for example, shows “pathological inspection accepted” is displayed on the endoscopic inspection report screen as shown in FIG. 7.

On the other hand, when the endoscopic sector system 20 accepts the correction input in Step S20, a corrected pathological inspection request document corresponding to the corrected endoscopic inspection report is sent again from the endoscopic sector server 21 to the pathological sector server 31.

Upon detection of a transmission instruction to send the corrected pathological inspection request document again, the endoscopic sector system 20 advances its processing from Step S13 to Step S22 through Step S14 in FIG. 8. In Step S22, the endoscopic sector system 20 sends an inquiry to the pathological sector server 31 about status information and determines whether pathological inspection has been started or not, based on the contents of the received status information, in the same manner as in the aforementioned S19.

When pathological inspection has not yet been started, the endoscopic sector system 20 moves its processing from Step S22 to Step S15 to send the corrected pathological inspection request document again from the endoscopic sector server 21 to the pathological sector server 31. On the contrary, when pathological inspection has been started, the endoscopic sector system 20 moves its processing to Step S23 to reject the instruction to send the corrected pathological inspection request document again. In this case, as soon as the pathological inspection request button 51 is pushed down on the pathological inspection request screen as shown in FIG. 6, the notification window 53 which shows, for example, “correction rejected because pathological inspection has been accepted”, is displayed in the pathological inspection request screen.

In this way, the consistency between the endoscopic inspection report and the pathological inspection request document can be secured, thereby securing data consistency between the endoscopic sector and the pathological inspection sector.

In the described endoscopic inspection and the pathological inspection, it is assumed that one pathological inspection request of one specimen is issued with respect to one endoscopic inspection order when the pathological inspection request is issued from the endoscopic sector to the pathological inspection sector. The cooperative processing can be applied to a case where plural pathological inspection requests of plural specimens are issued with respect to one endoscopic inspection order. The pathological inspection includes biopsy and cytodiagnosis. In the biopsy, one pathological inspection of one specimen is often conducted with respect to one endoscopic inspection order. On the other hand, in the cytodiagnosis, plural pathological inspections of plural specimens are often conducted with respect to one endoscopic inspection order. Hereinafter, assuming that the endoscopic sector requests the cytodiagnosis to the pathological inspection sector, issuing plural pathological inspection requests of plural specimens is exemplified.

When conducting the cytodiagnosis, the person in charge operates the client PC 22 to create plural pathological inspection request documents at one time so as to request pathological inspections for the respective specimens in the endoscopic sector. And, electronic data of each of the created pathological inspection request documents is transmitted from the endoscopic sector server 21 to the pathological sector server 31. The plural specimens are delivered to the pathological inspection sector together with hard copies of the pathological inspection request documents.

In the pathological inspection sector, the pathological sector server 31 receives the plural pathological inspection request documents and start managing the plural pathological inspection request documents. Specifically, the pathological sector server 31 initializes a piece of status information indicating the processing state of each pathological inspection request document, and registers the piece of status information in accordance with each processing state as described above. The registration updates the piece of status information corresponding to each pathological inspection request document. When a change request of the pathological inspection request information is issued from the endoscopic sector to the pathological inspection sector, the pathological sector server 31 determines whether the pathological inspection request information can be changed or not in accordance with each of the pathological inspection request documents.

Therefore, the endoscopic sector server 21 can individually inquires about the pathological inspection request documents having been already issued. If the processing state of the subject pathological inspection request document can be changed, the endoscopic sector server 21 can change the content of the subject pathological inspection request document recorded in the pathological sector server 31.

Each of the plural specimens delivered from the endoscopic sector server 21 is subjected to the corresponding pathological inspection based on the pathological inspection request document by the person in charge of the pathological inspection sector. The pathological sector server 31 transmits the pathological inspection result based on each of the pathological inspection request documents to the endoscopic sector server 21, to thereby transmit it to the endoscopic sector. In the endoscopic sector, the transmitted pathological inspection results are used for creating a report of the corresponding endoscopic inspection order. As a result, the plural pathological inspection results of the cytodiagnosis are summarized to one endoscopic inspection report.

In this way, even when plural specimens are sampled with respect to one endoscopic inspection order and pathological inspection requests for the respective specimens are issued, data consistency between each of these pathological inspection requests and the content of the endoscopic inspection report can be secured, thereby surely securing data consistency among the medical sectors.

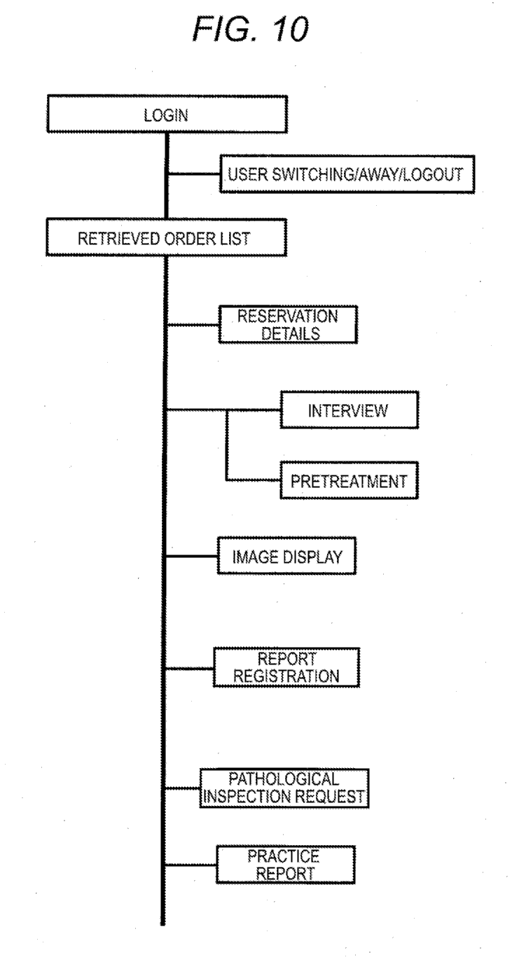

Next, description will be made on main functions and specific examples of screen displays provided by execution of the program installed in the client PC of the endoscopic sector system. FIG. 10 shows the main functions provided by the program installed in the client PC and state transitions among the functions.

As shown in FIG. 10, the program provides a login function, a logout function, an order retrieval function, an interview/pretreatment function, an image display function, a report registration function, a pathological inspection request function, and a practice report function. Each function will be described below.

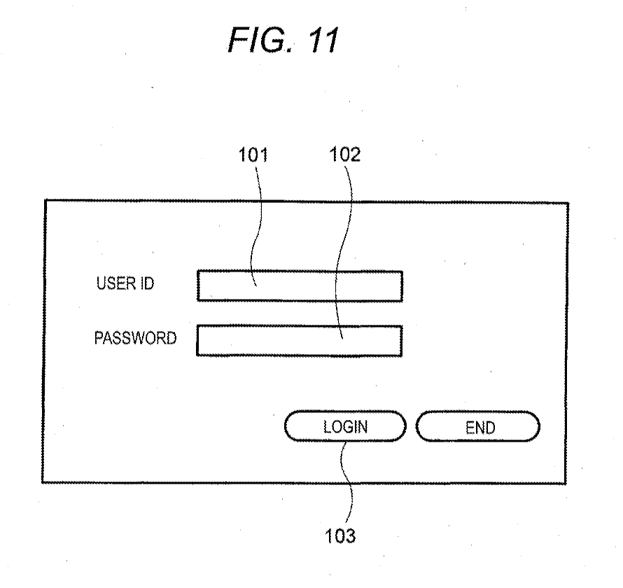

First, FIG. 11 shows an example of a screen to be displayed when the login function is actuated. The login screen shown in FIG. 11 is displayed immediately after the program is started up. A user ID entry field 101 and a password entry field 102 are displayed on the login screen. When a login button 103 is clicked with a set user ID and a set password in the user ID entry field 101 and the password entry field 102, the endoscopic sector server 21 checks the inputted user ID and password to perform user authentication. When the user authentication is successful in the endoscopic sector server 21, the login is completed.

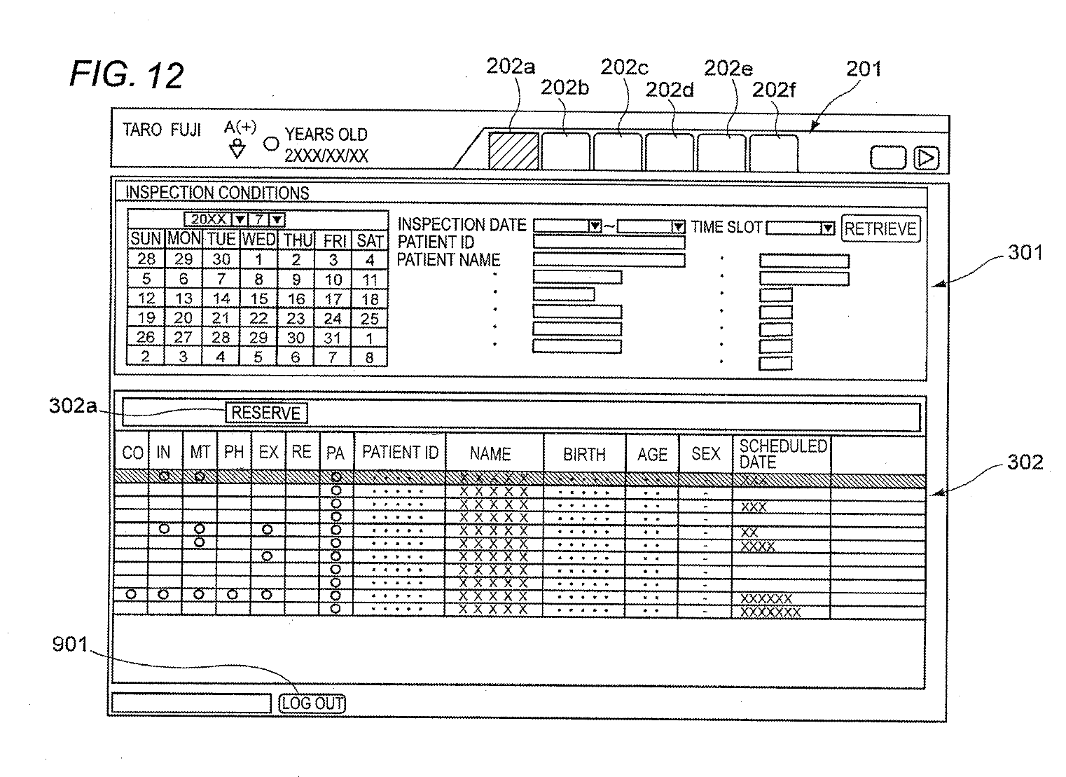

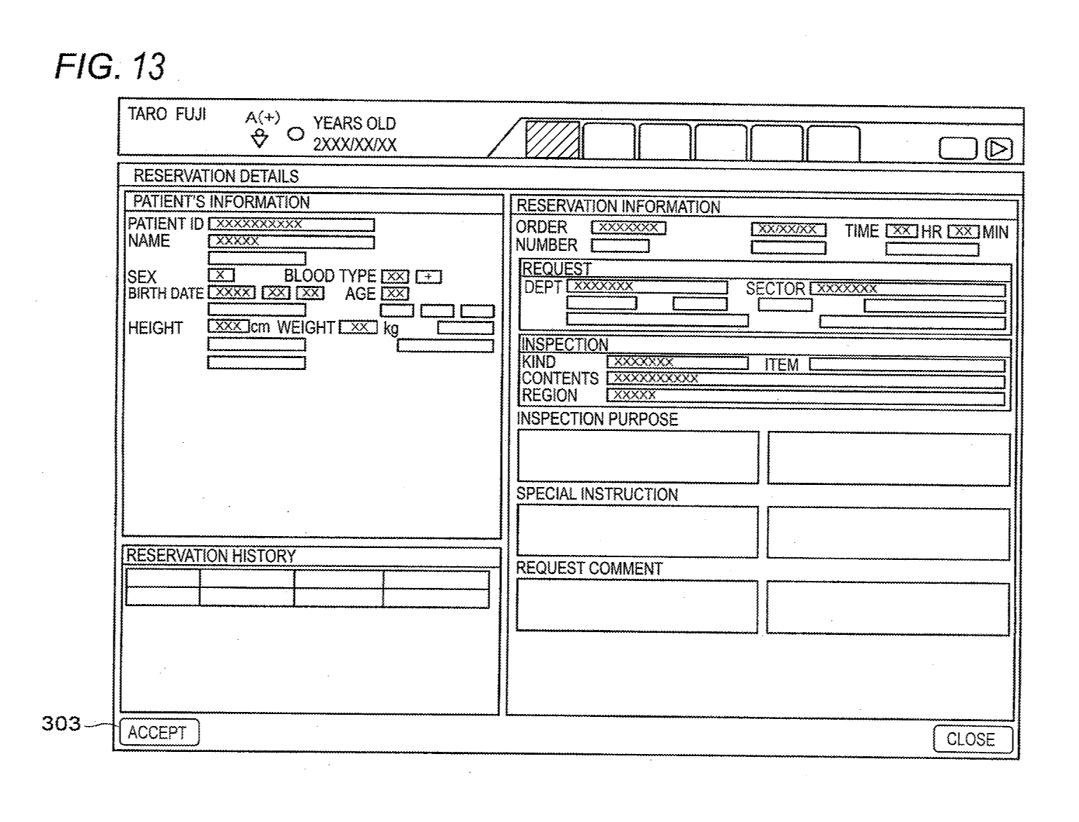

Next, FIGS. 12 and 13 show examples of a screen to be displayed when the order retrieval function is actuated. The order retrieval screen shown in FIG. 12 is displayed after the login completion. The order retrieval screen is roughly constituted by a launcher bar 201 in the upper portion of the screen, a retrieval condition setting region 301 in the central portion of the screen, and a retrieval result display region 302 in the lower portion of the screen.

An inspection list icon 202a, an interview/pretreatment icon 202b, an image display icon 202c, a report icon 202d, a pathological inspection request icon 202e and a practice report icon 202f are displayed in the launcher bar 201. The icons 202a to 202f are used to actuate various functions provided by the program, and a predetermined function is assigned to each icon. Specifically, the order retrieval function is assigned to the inspection list icon 202a, the interview/pretreatment function is assigned to the interview/pretreatment icon 202b, the image display function is assigned to the image display icon 202c, the report registration function is assigned to the report icon 202d, the pathological inspection request function is assigned to the pathological inspection request icon 202e, and the practice report function is assigned to the practice report icon 202f. As soon as each icon is clicked, the screen is replaced by a screen corresponding to the function assigned to the clicked icon. The launcher bar 201 is always displayed in the upper region of any function screen by which the screen is replaced.

A form in which various retrieval conditions can be inputted for retrieving inspection request information recorded in the database DB is displayed in the retrieval condition setting region 301. Inspection date, time slot, patient ID, patient name, etc. are set as the retrieval conditions by way of example.

Of inspection request information recorded in the database DB, pieces corresponding to the retrieval conditions set in the retrieval condition setting region 301 are listed and displayed in the retrieval result display region 302. When one piece is selected from the pieces of inspection request information displayed in the retrieval result display region 302, information about various operations including acceptance, interview/pretreatment, image display, report registration, pathological inspection request and practice report subordinate to the inspection in the selected piece of inspection request information can be referred to, edited and registered subsequently.

For example, when a patient visits the hospital for the sake of inspection, inspection request information is retrieved in the reception desk 20A (see FIG. 2) based on patient's information such as the name of the patient, the date, etc., and one piece of inspection request information is selected from pieces of inspection request information listed and displayed as pieces corresponding to retrieval conditions. When a reserve button 302A is clicked in this state, the details of the selected piece of inspection request information is displayed as shown in FIG. 13. The details of the inspection request information are checked with the patient's information, the date, etc. When it is confirmed that the selected piece of inspection request information is a desired piece of inspection request information, an accept button 303 is clicked for acceptance. The information of acceptance is supplied to the endoscopic sector server 21 through the client PC 22, and registered into the database DB in association with the selected piece of inspection request information.

When any one of the interview/pretreatment icon 202b, the image display icon 202c, the report icon 202d, the pathological inspection request icon 202e and the practice report icon 202f in the launcher bar 201 is clicked in the state where one piece of inspection request information has been selected in the retrieval result display region 302, the screen is replaced by a function screen corresponding to the clicked icon. On the function screen by which the screen is replaced, information about various operations subordinate to the inspection in the selected piece of inspection request information can be referred to, edited and registered subsequently.

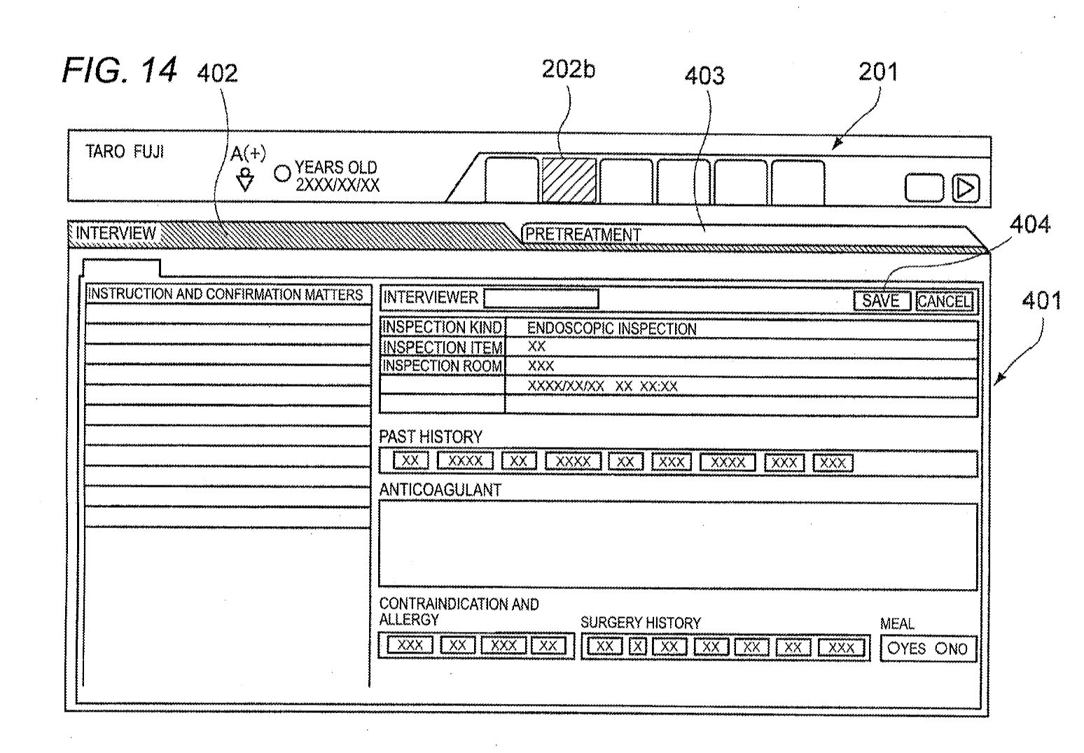

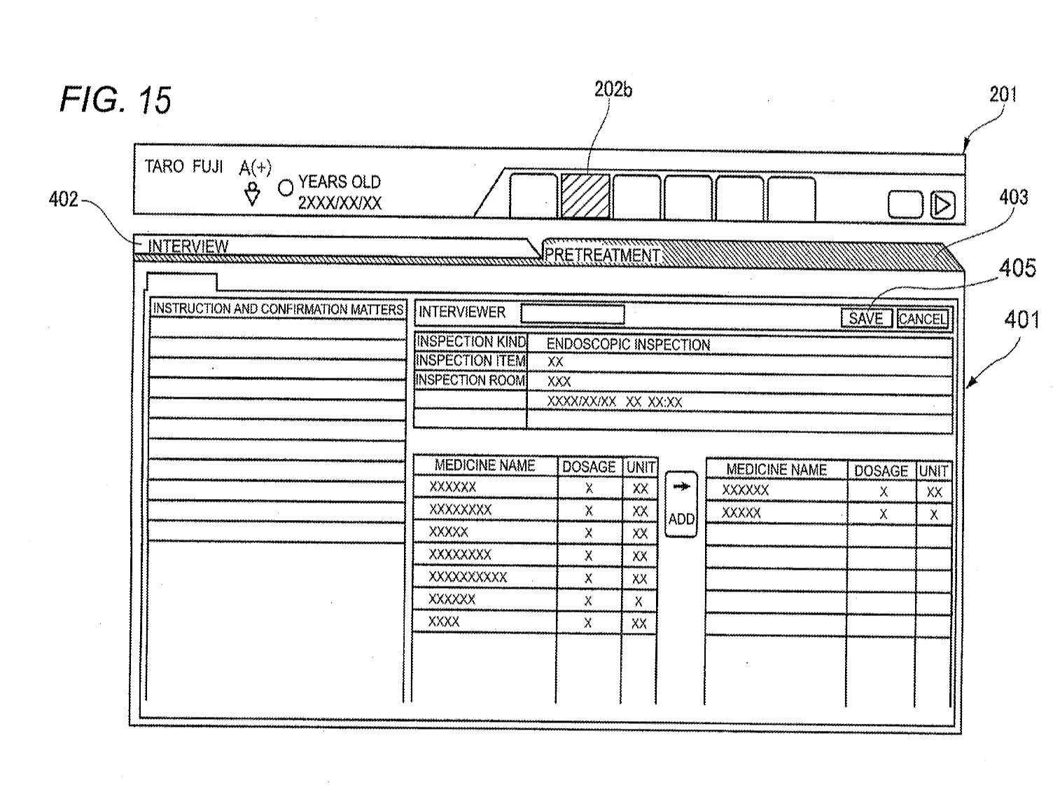

Next, FIGS. 14 and 15 show examples of a screen to be displayed when the interview/pretreatment function is actuated. The interview/pretreatment screen shown in FIGS. 14 and 15 is displayed when the interview/pretreatment icon 202b in the launcher bar 201 is clicked. The interview/pretreatment screen is roughly constituted by the launcher bar 201 and an input region 401 for inputting interview/pretreatment information.

A form for inputting interview information obtained by interview, such as a past history of a patient, and a form for inputting pretreatment information such as medicines etc. given to the patient as pretreatment are alternatively displayed in the input region 401. The displayed form can be switched by selection of a tub 402, 403 provided in the upper portion of the input region 401.

FIG. 14 shows a state where the interview form is displayed in the input region 401. When a save button 404 is clicked, interview information inputted in each field of the form is registered in the database DB in association with the selected piece of inspection request information. When interview information has been recorded in the database DB in association with the selected piece of inspection request information, the interview information is displayed in each field of the form.

FIG. 15 shows a state where the pretreatment form is displayed in the input region 401. When a save button 405 is clicked, pretreatment information inputted in each field of the form is registered in the database DB in association with the selected piece of inspection request information. When pretreatment information has been recorded in the database DB in association with the selected piece of inspection request information, the pretreatment information is displayed in each field of the form.

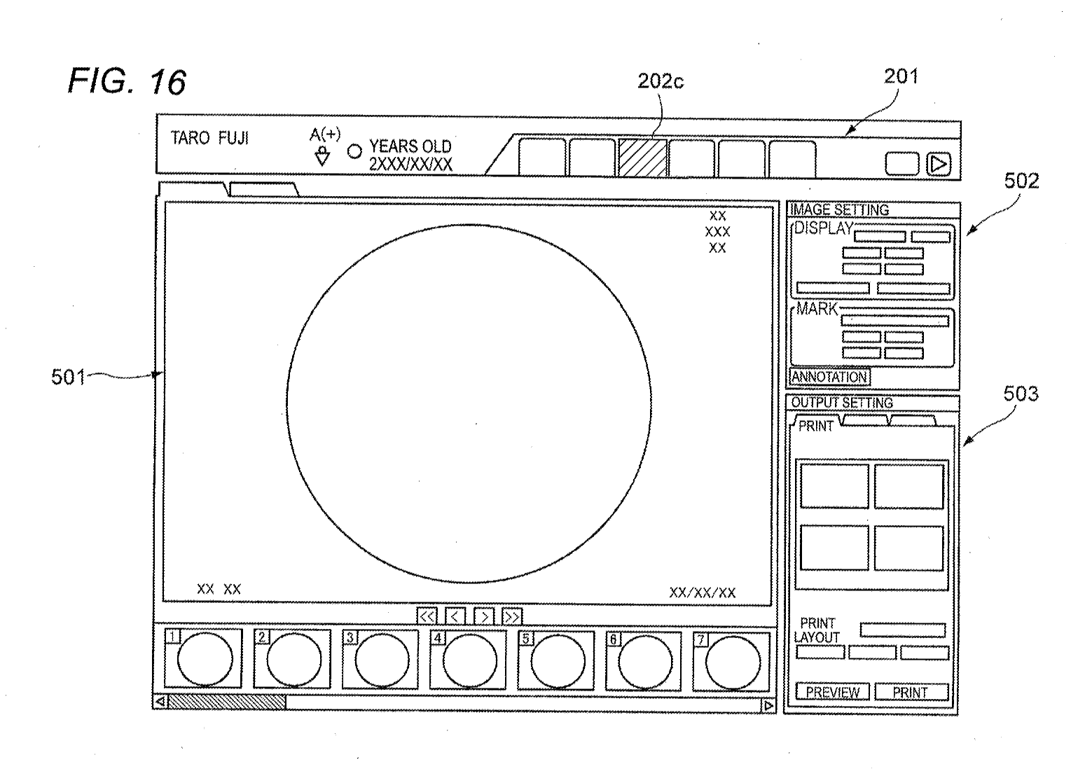

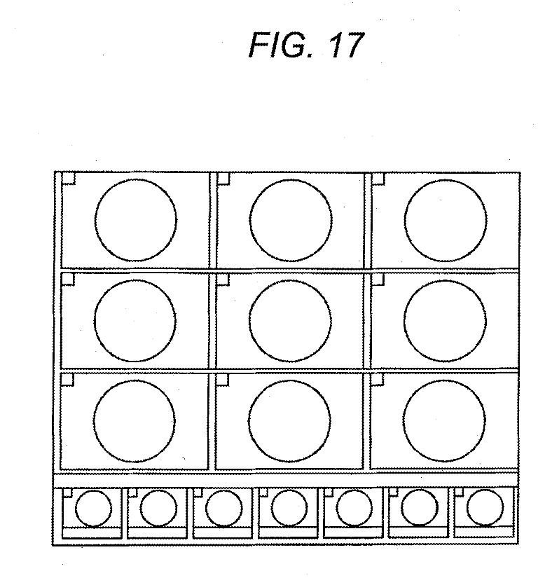

FIGS. 16 and 17 show examples of a screen to be displayed when the image display function is actuated. The image display screen shown in FIGS. 16 is displayed when the image display icon 202c in the launcher bar 201 is clicked. The image display screen is roughly constituted by the launcher bar 201, an image display region 501, an image setting region 502 and an output setting region 503.

Of image information captured by the endoscopic inspection devices 24 (see FIG. 2) and saved in the PACS 40 (see FIG. 1) in association with respective pieces of inspection request information, pieces associated with the selected piece of inspection request information are displayed as images in the image display region 501. In the display example of FIG. 16, a plurality of pieces of image information are listed and displayed as thumbnail images in the image display region 501, and a selected piece of those pieces of image information is displayed as an image larger than any other thumbnail image.

Buttons for setting a method for displaying images in the image display region 501 are displayed in the image setting region 502. As shown in FIG. 17, an example of the display method may include a method in which a large number of selected images are arranged side by side and displayed in a reduced manner as compared with the example of FIG. 16. In addition, buttons for performing marking and annotation on selected images are displayed in the image setting region 502. Marking is to add a predetermined mark to an,image so as to make it clearly understood that the image corresponds to a specific case. Annotation is to draw a desired comment, a desired graphic, etc. Marks added by marking, comments drawn by annotation, etc. are stored in the PACS 40 together with image information of images where the marks and the comments are added and drawn. Buttons etc. for setting output processing for selected images, such as printing, are displayed in the output setting region 503.

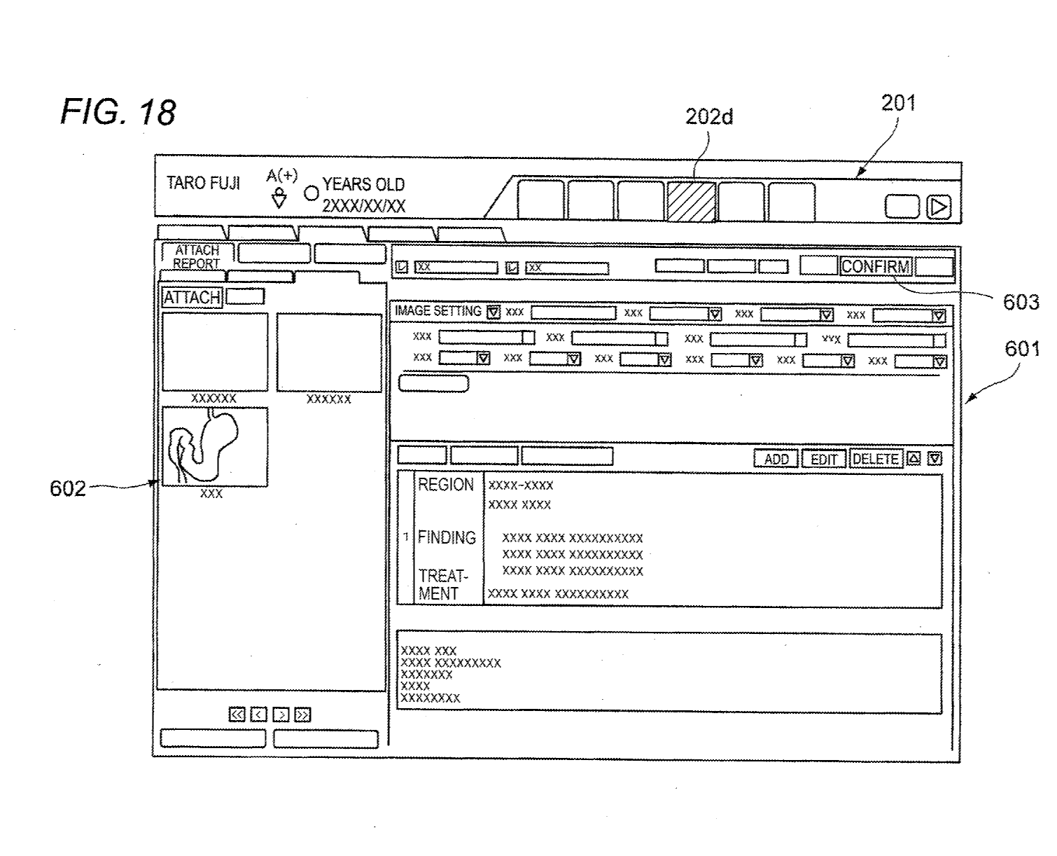

Next, FIG. 18 shows an example of a screen to be displayed when the report registration function is actuated. The report registration screen shown in FIG. 18 is displayed when the report icon 202d of the launcher bar 201 is clicked. The report registration screen is roughly constituted by the launcher bar 201, a report information input region 601 and an attached information setting region 602.

A form for inputting report information such as findings, diagnosis, etc. in inspection is displayed in the report information input region 601. Report information inputted in each field of the form is registered in the database DB in association with the selected piece of inspection request information when a decide button 603 is clicked.

Information to be attached to the report, such as information of images captured by the endoscopic inspection device 24, is displayed in the attached information setting region 602. The image information has been stored in the PACS 40 in association with the selected piece of inspection request information. Image information selected in advance on the aforementioned image display screen (see FIG. 16) is attached.

When report information has been recorded in the database DB in association with the selected piece of inspection request information, the report information is displayed in each field of the form in the report information input region 601. In addition, information such as image information attached to the report is displayed in the attached information setting region 602.

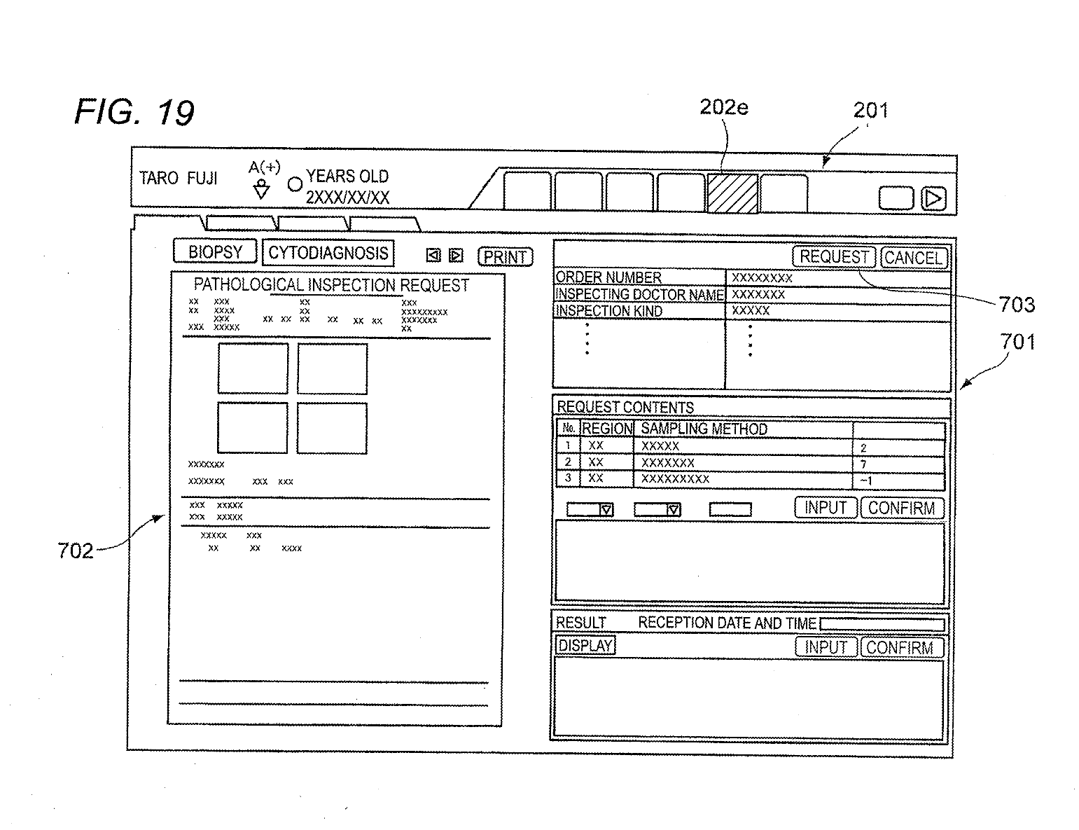

FIG. 19 shows an example of a screen to be displayed when the pathological inspection request function is actuated. The pathological inspection request screen shown in FIG. 19 is displayed when the pathological inspection request icon 202e of the launcher bar 201 is clicked. The pathological inspection request screen is roughly constituted by the launcher bar 201, a pathological inspection request information input region 701 and a preview region 702.

A form for inputting request information for pathological inspection is displayed in the pathological inspection request information input region 701. When a pathological inspection request button 703 is clicked, pathological inspection request information inputted in each field of the form is registered in the database DB in association with the selected piece of inspection request information, and also transmitted to the pathological sector system 30 (see FIG. 1) through the hospital LAN 60 (see FIG. 1). When pathological inspection request information has been recorded in the database DB in association with the selected piece of inspection request information, the pathological inspection request information is displayed in each field of the form in the pathological inspection request information input region 701.

A preview of a pathological inspection request document created based on the pathological inspection request information inputted in the form of the pathological inspection request information input region 701 is displayed in the preview region 702.

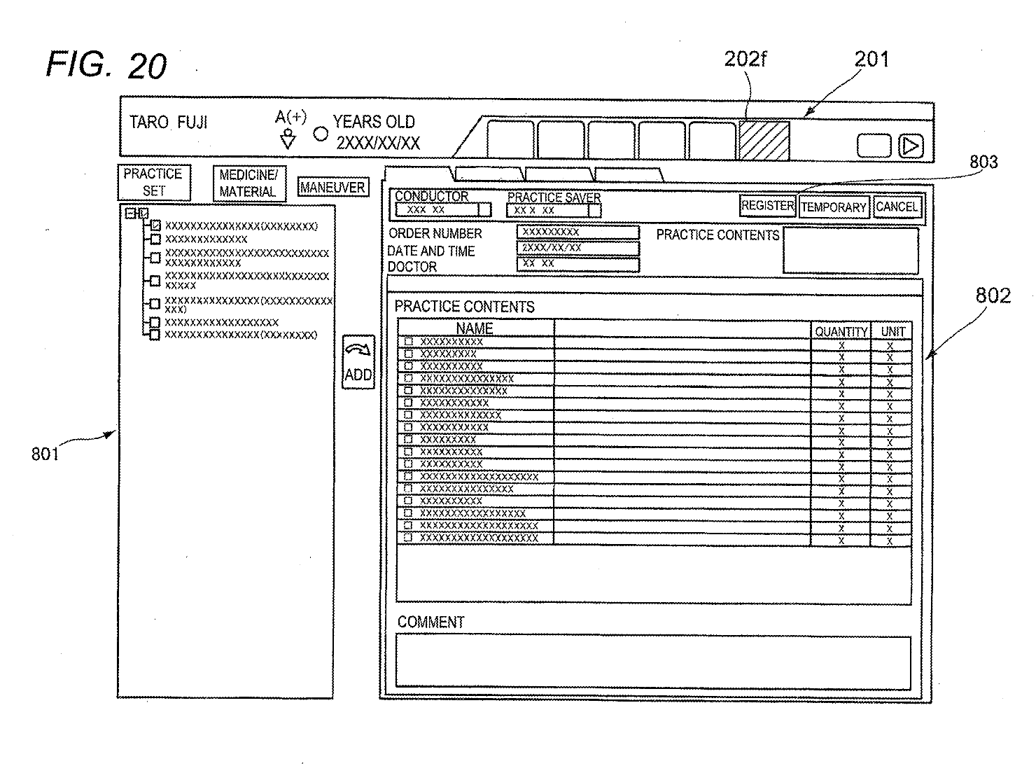

Next, FIG. 20 shows an example of a screen to be displayed when the practice report function is actuated. The practice report screen shown in FIG. 20 is displayed when the practice report icon 202f of the launcher bar 201 is clicked. The practice report screen is roughly constituted by the launcher bar 201, a selection region 801 for selecting maneuvers, medicines and materials, and a practice information input region 802.

Maneuvers, medicines, materials such as tools, etc. for inspection are listed and displayed in the selection region 801. Of those, maneuvers used actually in inspection, medicines and materials used for pretreatment and inspection are selected.

The maneuvers, medicines and materials selected in the selection region 801 are displayed in the practice information input region 802. The practice information displayed in the practice information input region 802 is registered in the database DB in association with the selected piece of inspection request information when a register button 803 is clicked. Billing is carried out based on the practice information registered here. When practice information has been registered in the database DB in association with the selected piece of inspection request information, the practice information is displayed in each field of the practice information input region 802.

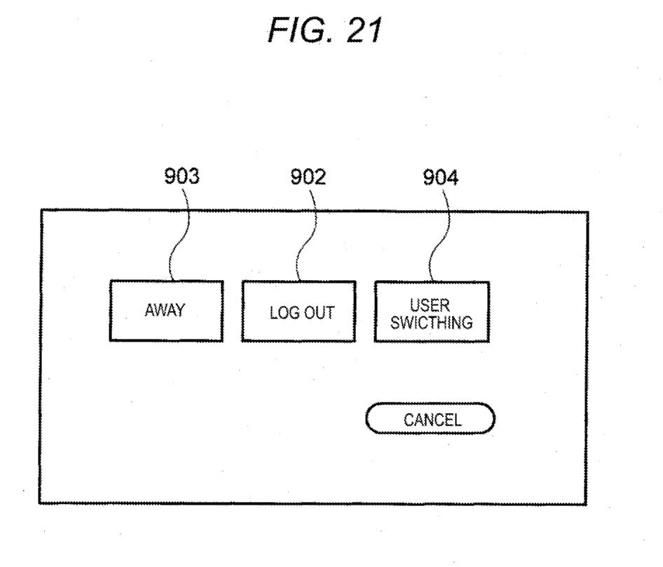

Next, FIG. 21 shows an example of a screen to be displayed when the logout function is actuated. The logout screen shown in FIG. 21 is displayed when a logout button 901 displayed in the lower area of the aforementioned order retrieval screen is clicked on the order retrieval screen. On the logout screen, an away button 903 and a user switching button 904 are displayed as well as a logout button 902. When the away button 903 is clicked, the login screen shown in FIG. 11 is displayed on the whole of the screen to hide information which has been displayed on the screen till then and to prevent others from operating thereon. When the user switching button 904 is clicked, a login user can be switched without returning to the login screen shown in FIG. 11.

Thus, the invention is not limited to the aforementioned embodiment, but modifications and applications which may be made by those skilled in the art based on the description in this specification and well-known techniques are also intended by the invention and included in the scope to be protected.

As described above, the following matters are disclosed in this specification.

It is disclosed a cooperative system among medical sectors for allowing an endoscopic sector and a pathological sector to share at least a part of information included in an endoscopic inspection report, includes: an endoscopic sector server; a pathological sector server which is connected to the endoscopic sector server through a communication network; a pathological inspection request information transmission unit which transmits pathological inspection request information from the endoscopic sector to the pathological sector, the pathological inspection request information being created by use of at least a part of information included in the endoscopic inspection report and for requesting the pathological sector to perform pathological inspection; a pathological sector status information management unit which receives the transmitted pathological inspection request information on the pathological sector server side and manages status information indicating a state of processing on the received pathological inspection request information in the pathological sector; a change request unit which issues a change request to change the transmitted pathological inspection request information corresponding to the endoscopic inspection report when there occurs a change in the information of the endoscopic inspection report; a change validity determination unit which acquires the status information of the pathological inspection request information to be changed from the pathological sector status information management unit upon reception of the change request from the change request unit, and determines whether the pathological inspection request information can be changed or not; and a change execution unit which changes the corresponding pathological inspection request information based on the change request when the change validity determination unit concludes that the pathological inspection request information can be changed, and transmits a change rejection notification indicating rejection of the change request to the endoscopic sector when the change validity determination unit concludes that the pathological inspection request information cannot be changed.

With this configuration, a part of data can be substantially shared between the endoscopic sector and the pathological sector. Thus, cooperativity between the sectors can be enhanced to achieve an efficient work. That is, an error or a point to be changed may be found in the description contents of a report created by the endoscopic sector after a pathological inspection request document is created based on the report and transmitted to the pathological sector. Even in such a case, the pathological inspection request document can be changed if predetermined conditions arc satisfied. In addition, data between the contents of the request in the endoscopic sector and the inspection result in the pathological sector can be prevented from mismatching due to the change of the pathological inspection request document. Due to the provision of the pathological sector status information management unit and the change validity determination unit, the validity of the change can be automatically determined.

In the disclosed cooperative system, the pathological sector status information management unit may manage at least a pathological inspection order creation status indicating whether a pathological inspection order for the pathological inspection request information received on the pathological sector server side has been created or not.

With this configuration, whether a pathological inspection order for each piece of pathological inspection request information has been created in the pathological sector or not can be determined with reference to the pathological inspection order creation status managed by the pathological sector status information management unit. If the pathological inspection order has been created, the pathological inspection request information corresponding thereto can be regarded as completely accepted in the pathological sector. It can be therefore concluded that the pathological inspection request information cannot be changed. If the pathological inspection order has not yet been created, it can be concluded that the pathological inspection request information can be changed.

In the disclosed cooperative system, the pathological sector status information management unit may manage at least a pathological inspection start status indicating whether pathological inspection for the pathological inspection request information received on the pathological sector server side has been actually started or not.

With the configuration, whether pathological inspection for each piece of pathological inspection request information has been actually started in the pathological sector or not can be determined with reference to the pathological inspection start status managed by the pathological sector status information management unit. If the pathological inspection has been started, the change of the pathological inspection request information corresponding thereto may cause confusion. It can be therefore concluded that the pathological inspection request information cannot be changed. If the pathological inspection has not yet been started, it can be concluded that the pathological inspection request information can be changed.

In the disclosed cooperative system among medical sectors, the pathological sector status information management unit may manage at least a specimen arrival status indicating whether a corresponding subject to be pathologically inspected for the pathological inspection request information received on the pathological sector server side has arrived at the pathological sector or not.

With this configuration, whether a subject to be pathologically inspected (specimen) corresponding to each piece of pathological inspection request information has arrived at the pathological sector or not can be determined with reference to the specimen arrival status managed by the pathological sector status information management unit. When the subject to be pathologically inspected has arrived, it is highly likely that inspection in the pathological sector has been started. In order to avoid confusion, it can be therefore concluded that the pathological inspection request information cannot be changed. When the subject to be pathologically inspected has not yet arrived, it can be concluded that the pathological inspection request information can be changed.

In the disclosed cooperative system, the pathological sector status information management unit may record at least one piece of time information corresponding to a timing of change in the state of the status information.

With this configuration, presence/absence or changed timing of each status in the status information can be grasped from time. Thus, management becomes easier.

In the disclosed cooperative system, the cooperative system may further include a notification unit which outputs a notification signal indicating that the pathological inspection has been accepted to the endoscopic sector server when whether the endoscopic inspection report can be changed or not is determined with reference to the status information of the pathological sector status information management unit and it is concluded that the endoscopic inspection report cannot be changed because the pathological inspection request information using the endoscopic inspection report has been transmitted, in the case where the endoscopic inspection report should be changed.

With this configuration, an input operator can be informed of circumstances and warned about the operation of change on the endoscopic inspection report corresponding to the transmitted pathological inspection request information in accordance with necessity.

In the disclosed cooperative system, the pathological inspection request information may include pieces of information about pathological inspection requests corresponding to respective specimens.

With this configuration, even when requesting the plural pathological inspections of the plural specimens for cytodiagnosis, data consistency between the medical sectors can be secured in accordance with the respective pieces of pathological inspection request information for the specimens.

Further, it is disclosed a cooperative processing method among medical sectors using a system having an endoscopic sector server and a pathological sector server connected to each other through a communication network, and allowing an endoscopic sector and a pathological sector to share at least a part of information included in an endoscopic inspection report, includes: transmitting pathological inspection request information from the endoscopic sector to the pathological sector, the pathological inspection request information being created by use of at least a part of information included in the endoscopic inspection report and for requesting the pathological sector to perform pathological inspection; receiving the transmitted pathological inspection request information on the pathological sector server side and managing status information indicating a state of processing on the received pathological inspection request information in the pathological sector; issuing a change request to change the transmitted pathological inspection request information corresponding to the endoscopic inspection report when there occurs a change in the information of the endoscopic inspection report; and acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

With this configuration, a part of data can be substantially shared between the endoscopic sector and the pathological sector. Thus, cooperativity between the sectors can be enhanced to achieve an efficient work. That is, an error or a point to be changed may be found in the description contents of a report created by the endoscopic sector after a pathological inspection request document is created based on the report and transmitted to the pathological sector. Even in such a case, the pathological inspection request document can be changed if predetermined conditions are satisfied. In addition, data between the contents of the request in the endoscopic sector and the inspection result in the pathological sector can be prevented from mismatching due to the change of the pathological inspection request document. Due to the management of the status information, the validity of the change can be automatically determined.

In the disclosed cooperative processing method, at least one of a pathological inspection order creation status, a pathological inspection start status and a specimen arrival status may be used as the status information, the pathological inspection order creation status indicating whether a pathological inspection order for the pathological inspection request information received on the pathological sector server side has been created or not, the pathological inspection start status indicating whether pathological inspection for the pathological inspection request information received on the pathological sector server side has been actually started in the pathological sector or not, the specimen arrival status indicating whether a corresponding subject to be pathologically inspected for the pathological inspection request information received on the pathological sector server side has arrived at the pathological sector or not.

With this configuration, whether each piece of pathological inspection request information can be changed or not can be determined with reference to any one of pieces of status information corresponding to the pathological inspection request information. That is, whether a pathological inspection order has been created or not can be determined by the pathological inspection creation status; whether pathological inspection has been started or not can be determined by the pathological inspection start status; and whether a subject to be pathologically inspected has arrived at the pathological sector or not can be determined by the specimen arrival status.

In the disclosed cooperative processing method, at least one piece of time information corresponding to a timing of change in the state of the status information may be recorded for management of the status information.

With this configuration, presence/absence or changed timing of each status in the status information can be grasped from time. Thus, management becomes easier.

In the disclosed cooperative processing method, the cooperative processing method may further include: outputting a notification signal indicating that the pathological inspection has been accepted to the endoscopic sector server when whether the endoscopic inspection report can be changed or not is determined with reference to the status information and it is concluded that the endoscopic inspection report cannot be changed because the pathological inspection request information using the endoscopic inspection report has been transmitted, in the case where the endoscopic inspection report should be changed.

With this configuration, an input operator can be informed of circumstances and warned about the operation of change on the endoscopic inspection report corresponding to the transmitted pathological inspection request information in accordance with necessity.

In the cooperative processing method among medical sectors, the pathological inspection request information may include pieces of information about pathological inspection requests corresponding to respective specimens.

With this configuration, even when requesting the plural pathological inspections of the plural specimens for cytodiagnosis, data consistency between the medical sectors can be secured in accordance with the respective pieces of pathological inspection request information for the specimens.

Further, it is disclosed a computer readable medium stores a program causing a computer to execute a process for a cooperative processing method among medical sectors using a system having an endoscopic sector server and a pathological sector server connected to each other through a communication network, and allowing an endoscopic sector and a pathological sector to share at least a part of information included in an endoscopic inspection report, the process including: transmitting pathological inspection request information from the endoscopic sector to the pathological sector, the pathological inspection request information being created by use of at least a part of information included in the endoscopic inspection report and for requesting the pathological sector to perform pathological inspection; receiving the transmitted pathological inspection request information on the pathological sector server side and managing status information indicating a state of processing on the received pathological inspection request information in the pathological sector; issuing a change request to change the transmitted pathological inspection request information corresponding to the endoscopic inspection report when there occurs a change in the information of the endoscopic inspection report; and acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

When the program stored in the computer readable medium is executed by a computer administering a predetermined system, a part of data can be substantially shared between the endoscopic sector and the pathological sector. Thus, cooperativity between the sectors can be enhanced to achieve an efficient work. That is, an error or a point to be changed may be found in the description contents of a report created by the endoscopic sector after a pathological inspection request document is created based on the report and transmitted to the pathological sector. Even in such a case, the pathological inspection request document can be changed if predetermined conditions are satisfied. In addition, data between the contents of the request in the endoscopic sector and the inspection result in the pathological sector can be prevented from mismatching due to the change of the pathological inspection request document. Due to the management of the status information, the validity of the change can be automatically determined.

In the disclosed computer readable medium, at least one of a pathological inspection order creation status, a pathological inspection start status and a specimen arrival status may be used as the status information, the pathological inspection order creation status indicating whether a pathological inspection order for the pathological inspection request information received on the pathological sector server side has been created or not, the pathological inspection start status indicating whether pathological inspection for the pathological inspection request information received on the pathological sector server side has been actually started in the pathological sector or not, the specimen arrival status indicating whether a corresponding subject to be pathologically inspected for the pathological inspection request information received on the pathological sector server side has arrived at the pathological sector or not.

With this configuration, whether each piece of pathological inspection request information can be changed or not can be determined with reference to any one of pieces of status information corresponding to the pathological inspection request information. That is, whether a pathological inspection order has been created or not can be determined by the pathological inspection creation status; whether pathological inspection has been started or not can be determined by the pathological inspection start status; and whether a subject to be pathologically inspected has arrived at the pathological sector or not can be determined by the specimen arrival status.

In the computer readable medium, at least one piece of time information corresponding to a timing of change in the state of the status information may be recorded for management of the status information.

With this configuration, presence/absence or changed timing of each status in the status information can be grasped from time. Thus, management becomes easier.

In the disclosed computer readable medium, the process may further include:

outputting a notification signal indicating that the pathological inspection has been accepted to the endoscopic sector server when whether the endoscopic inspection report can be changed or not is determined with reference to the status information and it is concluded that the endoscopic inspection report cannot be changed because the pathological inspection request information using the endoscopic inspection report has been transmitted, in the case where the endoscopic inspection report should be changed.

With this configuration, an input operator can be informed of circumstances and warned about the operation of change on the endoscopic inspection report corresponding to the transmitted pathological inspection request information in accordance with necessity.

In the disclosed computer readable medium,the pathological inspection request information may include pieces of information about pathological inspection requests corresponding to respective specimens.

With this configuration, even when requesting the plural pathological inspections of the plural specimens for cytodiagnosis, data consistency between the medical sectors can be secured in accordance with the respective pieces of pathological inspection request information for the specimens.

What is claimed is:

1. A cooperative system among medical sectors for allowing an endoscopic sector and a pathological sector to share at least a part of information included in an endoscopic inspection report, comprising:
an endoscopic sector server;
a pathological sector server which is connected to the endoscopic sector server through a communication network;
a pathological inspection request information transmission unit which transmits pathological inspection request information from the endoscopic sector to the pathological sector, the pathological inspection request information being created by use of at least a part of information included in the endoscopic inspection report and for requesting the pathological sector to perform pathological inspection;
a pathological sector status information management unit which receives the transmitted pathological inspection request information on the pathological sector server side and manages status information indicating a state of processing on the received pathological inspection request information in the pathological sector;
a change request unit which issues a change request to change the transmitted pathological inspection request information corresponding to the endoscopic inspection report when there occurs a change in the information of the endoscopic inspection report;
a change validity determination unit which acquires the status information of the pathological inspection request information to be changed from the pathological sector status information management unit upon reception of the change request from the change request unit, and determines whether the pathological inspection request information can be changed or not; and
a change execution unit which changes the corresponding pathological inspection request information based on the change request when the change validity determination unit concludes that the pathological inspection request information can be changed, and transmits a change rejection notification indicating rejection of the change request to the endoscopic sector when the change validity determination unit concludes that the pathological inspection request information cannot be changed.

2. The cooperative system among medical sectors according to claim 1, wherein:
the pathological sector status information management unit manages at least a pathological inspection order creation status indicating whether a pathological inspection order for the pathological inspection request information received on the pathological sector server side has been created or not.

3. The cooperative system among medical sectors according to claim 1, wherein:
the pathological sector status information management unit manages at least a pathological inspection start status indicating whether pathological inspection for the pathological inspection request information received on the pathological sector server side has been actually started or not.

4. The cooperative system among medical sectors according to claim 1, wherein:
the pathological sector status information management unit manages at least a specimen arrival status indicating whether a corresponding subject to be pathologically inspected for the pathological inspection request information received on the pathological sector server side has arrived at the pathological sector or not.

5. The cooperative system among medical sectors according to claim 1, wherein:
the pathological sector status information management unit records at least one piece of time information corresponding to a timing of change in the state of the status information.

6. The cooperative system among medical sectors according to claim 1, further comprising:
a notification unit which outputs a notification signal indicating that the pathological inspection has been accepted to the endoscopic sector server when whether the endoscopic inspection report can be changed or not is determined with reference to the status information of the pathological sector status information management unit and it is concluded that the endoscopic inspection report cannot be changed because the pathological inspection request information using the endoscopic inspection report has been transmitted, in the case where the endoscopic inspection report should be changed.

7. The cooperative system among medical sectors according to claim 6, wherein:
the pathological inspection request information includes pieces of information about pathological inspection requests corresponding to respective specimens.

8. A cooperative processing method among medical sectors using a system having an endoscopic sector server and a pathological sector server connected to each other through a communication network, and allowing an endoscopic sector and a pathological sector to share at least a part of information included in an endoscopic inspection report, comprising:
transmitting pathological inspection request information from the endoscopic sector to the pathological sector, the pathological inspection request information being created by use of at least a part of information included in the endoscopic inspection report and for requesting the pathological sector to perform pathological inspection;
receiving the transmitted pathological inspection request information on the pathological sector server side and managing status information indicating a state of processing on the received pathological inspection request information in the pathological sector;
issuing a change request to change the transmitted pathological inspection request information corresponding to the endoscopic inspection report when there occurs a change in the information of the endoscopic inspection report; and
acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

9. The cooperative processing method among medical sectors according to claim 8, wherein:
at least one of a pathological inspection order creation status, a pathological inspection start status and a specimen arrival status is used as the status information, the pathological inspection order creation status indicating whether a pathological inspection order for the pathological inspection request information received on the pathological sector server side has been created or not, the pathological inspection start status indicating whether pathological inspection for the pathological inspection request information received on the pathological sector server side has been actually started in the pathological sector or not, the specimen arrival status indicating whether a corresponding subject to be pathologically inspected for the pathological inspection request information received on the pathological sector server side has arrived at the pathological sector or not.

10. The cooperative processing method among medical sectors according to claim 9, wherein:
at least one piece of time information corresponding to a timing of change in the state of the status information is recorded for management of the status information.

11. The cooperative processing method among medical sectors according to claim 8, further comprising:
outputting a notification signal indicating that the pathological inspection has been accepted to the endoscopic sector server when whether the endoscopic inspection report can be changed or not is determined with reference to the status information and it is concluded that the endoscopic inspection report cannot be changed because the pathological inspection request information using the endoscopic inspection report has been transmitted, in the case where the endoscopic inspection report should be changed.

12. The cooperative processing method among medical sectors according to claim 8, wherein:
the pathological inspection request information includes pieces of information about pathological inspection requests corresponding to respective specimens.

13. A computer readable medium storing a program causing a computer to execute a process for a cooperative processing method among medical sectors using a system having an endoscopic sector server and a pathological sector server connected to each other through a communication network, and allowing an endoscopic sector and a pathological sector to share at least a part of information included in an endoscopic inspection report, the process comprising:
transmitting pathological inspection request information from the endoscopic sector to the pathological sector, the pathological inspection request information being created by use of at least a part of information included in the endoscopic inspection report and for requesting the pathological sector to perform pathological inspection;
receiving the transmitted pathological inspection request information on the pathological sector server side and managing status information indicating a state of processing on the received pathological inspection request information in the pathological sector;
issuing a change request to change the transmitted pathological inspection request information corresponding to the endoscopic inspection report when there occurs a change in the information of the endoscopic inspection report; and
acquiring the status information of the pathological inspection request information to be changed upon reception of the change request of the pathological inspection request information on the pathological sector server side, determining whether the pathological inspection request information can be changed or not, changing the corresponding pathological inspection request information based on the change request when it is concluded that the pathological inspection request information can be changed, and transmitting a change rejection notification indicating rejection of the change request to the endoscopic sector when it is concluded that the pathological inspection request information cannot be changed.

14. The computer readable medium according to claim 13, wherein:
at least one of a pathological inspection order creation status, a pathological inspection start status and a specimen arrival status is used as the status information, the pathological inspection order creation status indicating whether a pathological inspection order for the pathological inspection request information received on the pathological sector server side has been created or not, the pathological inspection start status indicating whether pathological inspection for the pathological inspection request information received on the pathological sector server side has been actually started in the pathological sector or not, the specimen arrival status indicating whether a corresponding subject to be pathologically inspected for the pathological inspection request information received on the pathological sector server side has arrived at the pathological sector or not.

15. The computer readable medium according to claim 14, wherein:
at least one piece of time information corresponding to a timing of change in the state of the status information is recorded for management of the status information.

16. The computer readable medium according to claim 13, further comprising:
outputting a notification signal indicating that the pathological inspection has been accepted to the endoscopic sector server when whether the endoscopic inspection report can be changed or not is determined with reference to the status information and it is concluded that the endoscopic inspection report cannot be changed because the pathological inspection request information using the endoscopic inspection report has been transmitted, in the case where the endoscopic inspection report should be changed.

17. The computer readable medium according to claim 13, wherein:
the pathological inspection request information includes pieces of information about pathological inspection requests corresponding to respective specimens.
